(19) United States
(12) Patent Application Publication
(10) Pub. No.: US 2018/0148600 A1
(43) Pub. Date: May 31, 2018

(54) ABRASION RESISTANT COATING COMPOSITION WITH INORGANIC METAL OXIDES

(71) Applicant: Momentive Performance Materials Inc., Waterford, NY (US)

(72) Inventors: Karthikeyan Murugesan, Bangalore (IN); Karthikeyan Sivasubramanian, Bangalore (IN); Indumathi Ramakrishnan, Bangalore (IN); Sumi Dinkar, Bangalore (IN); Vivek Khare, Bangalore (IN); Robert Hayes, Mechanicville, NY (US)

(21) Appl. No.: 15/634,102

(22) Filed: Jun. 27, 2017

Related U.S. Application Data
(60) Provisional application No. 62/427,848, filed on Nov. 30, 2016.

(51) Int. Cl. C09D 183/04; C09D 5/32; C09D 5/00

(52) U.S. Cl. CPC C09D 183/04; C08K 2003/2237; C09D 5/00; C09D 5/32

(57) ABSTRACT

The present technology provides a coating system including a curable silicone polymer and a catalyst, wherein the catalyst is selected from a super base, a salt of a super base, or a combination of two or more thereof.

### CROSS-REFERENCE TO RELATED APPLICATIONS

This Application claims priority to and the benefit of U.S. Provisional Application No. 62/427,848 filed on Nov. 30, 2016, the disclosure of which is incorporated herein by reference in its entirety

### FIELD

The disclosed subject matter relates to coating compositions or systems for coating a variety of substrates. In particular, the subject matter relates to a coating composition that provides an abrasion resistant coating, such as, for example, a hardcoat formulation.

### BACKGROUND

Polymeric materials, particularly thermoplastics such as polycarbonate, are promising alternatives to glass for use as structural material in a variety of applications, including automotive, transportation, and architectural glazing applications, where increased design freedom, weight savings, and improved safety features are in high demand. Plain polycarbonate substrates, however, are limited by their lack of abrasion, chemical, ultraviolet (UV), and weather resistance, and, therefore, need to be protected with optically transparent coatings that alleviate a polymer material's limitations for use in the aforementioned applications.

Silicone hardcoats have been traditionally used to improve the abrasion resistance and UV resistance of various polymers including polycarbonate and acrylics. This enables the use of polycarbonates in a wide range of applications, including architectural glazing and automotive parts such as headlights and windshields.

The addition of a thermally curable silicone hardcoat generally imparts abrasion resistance to the polymeric substrate. The addition of organic or inorganic UV-absorbing materials in the silicone hardcoat layer can improve the weatherability of the underlying polymeric substrate. A catalyst improves curing of these coatings under thermal conditions. Cure catalysts can play an important role in determining the performance of the hardcoat. An insufficient catalyst loading in the formulation can lead to incomplete curing of the coating, which will result in lower abrasion resistance of the coating. However, incorporating larger concentrations of catalyst is often detrimental to the long term weathering of the coating under thermal conditions. High catalyst loading may lead to embrittlement of the cured coating due to high levels of residual material in the matrix that is not part of the crosslinking network. This can then result in premature adhesion failure or cracking of the coatings as this material is lost during weathering. It is difficult to find catalysts that have high activity (and therefore require minimal loading) and exhibit improved stability compared to conventional ionic catalysts.

### SUMMARY

The present technology provides a coating system comprising a curable hardcoat composition and a catalyst, wherein the catalyst is selected from a super base, a salt of a super base, or a combination of two or more thereof. The use of these materials has been found to provide coating compositions with optimal abrasion, adhesion and mechanical properties like Hardness and modulus in final cured state, particularly in silicone-based hardcoat compositions. The catalyst can be used at lower loadings compared to conventional catalysts without compromising on long term performance, which may be measured by accelerated weathering studies. Curing can also be effected at a lower temperature and/or shorter times compared to conventional catalysts.

The present catalysts can also be used with inorganic UV absorbing materials and still provide a coating with optimal cure properties such as, for example, Hardness (H) and reduced modulus (Eᵣ) and protective coating properties such as abrasion resistance, and weatherability. Weatherability may be defined as the outdoor service life time of a coated article while maintaining the initial coating properties like transmission, Haze, adhesion, and abrasion resistance. It can be measured through weathering studies done under accelerated climate conditions involving radiation, temperature, and humidity changes using a Weatherometer.

In one aspect, provided is a curable silicone hardcoat system comprising (a) a curable silicone-based composition comprising a dispersion of at least one siloxanol resin and at least one colloidal metal oxide, and (b) at least one catalyst, wherein the catalyst is selected from a super base, a salt of a super base, or a combination of two or more thereof in one embodiment, the super base or salt of a super base is chosen from a compound having a pKa of about 11 or greater. In one embodiment, the super base or salt of a super base has a pKa of from about 11 to about 45.

In one embodiment, the catalyst is chosen from pyridinium, imidazolium, dialkylimidazolium, trialkylimidazolium, dialkylpyrrolidinium, mono or dialkylpyridinium, trialkylsulfonium, oxazolium, thiazolium, oxadiazolium, triazolium, piperidinium, pyrazolium, pyrimidinium, pyrazinium, triazinium, phosphonium, sulfonium, carbazolium, indolium and their derivatives, quaternary amines and quaternary phosphonium, a heterocyclic compound comprising at least one positively charged heteroatom, organosilicon/silane compound comprising one or more positively charged hetero atom or combinations of two or more thereof.

In one embodiment, the catalyst is chosen from a compound of the formula:

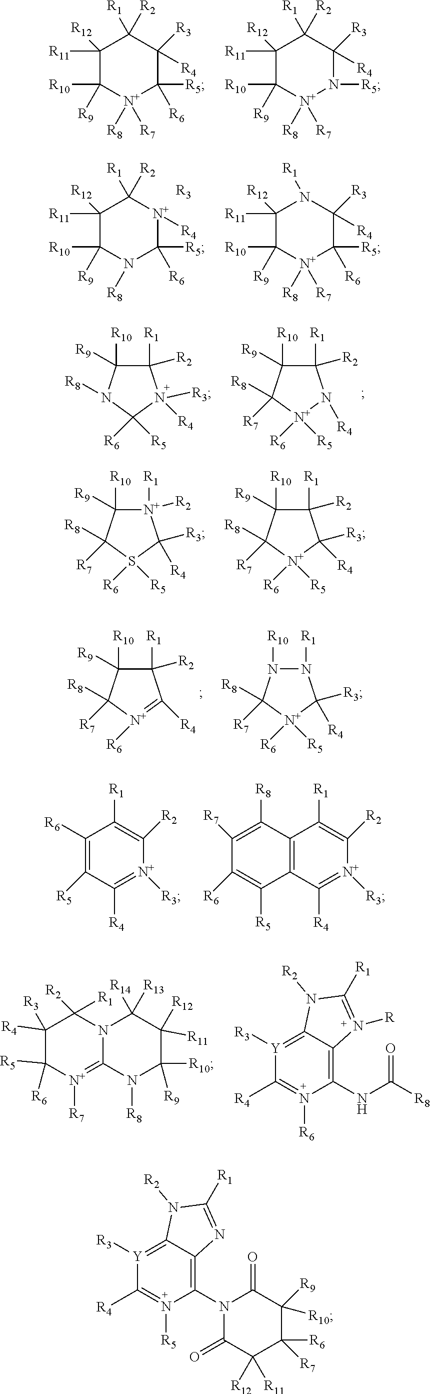

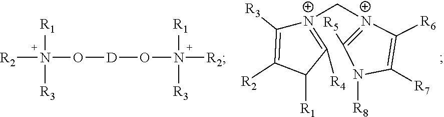

or combinations of two or more thereof, where R₁, R₂, R₃, R₄, R₅, R₆, R₇, R₈, R₉, R₁₀, R₁₁, and R₁₂ are independently chosen from hydrogen, an alkyl, a substituted alkyl, an alkenyl, a substituted alkenyl, an alkynyl, a substituted alkynyl, a carbocycle, a heterocycle, an aryl, or a heteroaryl, organosilicone compound having pendent or grafted cationic group selected from the group of pyridinium, imidazolium, dialkylimidazolium, trialkylimidazolium, dialkylpyrrolidinium, mono or dialkylpyridinium, trialkylsulfonium, oxazolium, thiazolium, oxadiazolium, triazolium, piperidinium, pyrazolium, pyrimidinium, pyrazinium, triazinium, phosphonium, sulfonium, carbazolium, indolium and their derivatives, quaternary amines and quaternary phosphonium, a heterocyclic compound comprising at least one positively charged heteroatom, organosilicon/silane compound comprising one or more positively charged hetero atom or combinations of two or more thereof, X and Y are chosen from heteroatoms such as nitrogen, oxygen, sulfur, and phosphorus, and D is chosen from the organo-functional silicon compound having pendent or grafted anionic groups selected from halides, sulfates, alkylsulfates, nitrates, acetates, cyanates, aluminates, borates, tosylates, carboxylates, phosphorous halides, boron halides, organosilicon/silane compound comprising one or more negatively charged hetero atom or combinations of two or more thereof.

In one embodiment, the super base is chosen from an imidazole of the formula:

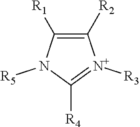

where R₁, R₂, R₃, R₄, and R₅ are independently chosen from hydrogen, an alkyl, a substituted alkyl, an alkenyl, a substituted alkenyl, an alkynyl, a substituted alkynyl, a carbocycle, a heterocycle, an aryl, or a heteroaryl, organosilicone compound having pendent or grafted cationic group selected from the group of pyridinium, imidazolium, dialkylimidazolium, trialkylimidazolium, dialkylpyrrolidinium, mono or dialkylpyridinium, trialkylsulfonium, oxazolium, thiazolium, oxadiazolium, triazolium, piperidinium, pyrazolium, pyrimidinium, pyrazinium, triazinium, phosphonium, sulfonium, carbazolium, indolium and their derivatives, quaternary amines and quaternary phosphonium, a heterocyclic compound comprising at least one positively charged heteroatom, organosilicon/silane compound comprising one or more positively charged hetero atom or combinations of two or more thereof.

In one embodiment, the catalyst is chosen from an imidazole compound of the formula:

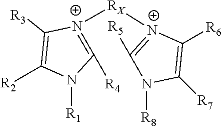

where Rₓ may be a C₁-C₂₀ alkylene, aralkylene comprising one or more heteroatom, an alkyl, a substituted alkyl, an alkenyl, a substituted alkenyl, an alkynyl, a substituted alkynyl, a carbocycle, a heterocycle, an aryl, or a heteroaryl; and R₁, R₂, R₃, R₄, R₅, R₆, R₇ and R₈ are as described above with respect to R₁-R₁₂.

In one embodiment, the catalyst is chose from a salt of a super base comprising an acid chosen from propanoic acid, 2-methyl propanoic acid, butanoic acid, pentanoic acid (valeric acid), hexanoic acid (caproic acid), 2-ethylhexanoic acid, heptanoic acid (enanthic acid), hexanoic acid, octanoic acid (caprylic acid), oleic acid, linoleic acid, linolenic acid, cyclohexanecarboxylic acid, cyclohexylacetic acid, cyclohexenecarboxylic acid, benzoic acid, benzeneacetic acid, propanedioic acid (malonic acid), butanedioic acid (succinic acid), hexanedioic acid (adipic acid), 2-butenedioic acid (maleic acid), lauric acid, stearic acid, myristic acid, palmitic acid, isoanoic acid, Versatic acid, lauric acid, acetic acid, stearic acid, myristic acid, palmitic acid, isoanoic acid, aminoacids; or a combination of two or more catalysts.

In one embodiment, the organic super base is selected from an amidine, guanidine, multicyclic polyamine, phosphazene, or a combination of two or more thereof.

In one embodiment, the catalyst is selected from compounds comprising one imidazole ring per molecule, including imidazole, 2-methylimidazole, 2-ethyl-4-methylimidazole, 2-methyl-4-ethyl imidazole, 2-undecylimidazole, 2-heptadecylimidazole, 2-phenylimidazole, 2-phenyl-4-methylimidazole, 1-benzyl-2-methylimidazole, 2-ethylimidazole, 2-isopropylimidazole, 2-phenyl-4-benzylimidazole, 1-cyanoethyl-2-methylimidazole, 1-cyanoethyl-2-ethyl-4-methylimidazole, 1-cyanoethyl-2-undecylimidazole, 1-cyanoethyl-2-isopropylimidazole, 1-cyanoethyl-2-phenylimidazole, 2,4-diamino-6-[2′-methylimidazolyl-(1)′]-ethyl-s-triazine, 2,4-diamino-6-[2′-ethyl-4-methylimidazolyl-(1)′]-ethyl-s-triazine, 2,4-diamino-6-[2′-undecylimidazolyl-(1)′]-ethyl-s-triazine, 2-methyl-imidazo-lium-isocyanuric acid adduct, 2-phenylimidazolium-isocyanuric acid adduct, 1-aminoethyl-2-methylimidazole, 2-phenyl-4,5-dihydroxymethylimidazole, 2-phenyl-4-methyl-5-hydroxymethylimidazole, 2-phenyl-4-benzyl-5-hydroxymethylimidazole, or combinations of two or more thereof.

In one embodiment, the catalyst is selected from compounds comprising 2 or more imidazole rings per molecule and condensing the compounds with formaldehyde.

In one embodiment, the coating system further comprises an inorganic UV-absorbing material, an organic UV-absorbing material, or a combination of two or more thereof. In one embodiment, the coating comprises an inorganic UV-absorbing material chosen from cerium oxide, titanium oxide, zinc oxide, iron oxide, or a combination of two or more thereof.

In one embodiment, the catalyst is provided in an amount ranging from about 1 ppm to about 75 ppm. In one embodiment, wherein the catalyst is provided in an amount ranging from about 10 ppm to about 70 ppm.

In one embodiment, the catalyst is provided in an amount ranging from about 20 ppm to about 60 ppm.

In one aspect, the present technology provides a coated article comprising a polymeric substrate and a coating as described in any of the foregoing embodiments disposed over at least a portion of the surface of the polymeric substrate.

In one embodiment, the coating system is a primerless system.

In one embodiment, a primer is disposed between the polymeric substrate and the coating.

In one embodiment, the coating system comprises an inorganic UV-absorbing material provided in an amount ranging from about 1 wt. % to about 50 wt. % of dry weight of the film after curing of the coating system.

In one embodiment, the coating system comprises an inorganic UV-absorbing material provided in an amount ranging from about 5 wt. % to about 40 wt. % of dry weight of the film after curing of the coating system.

In one embodiment, the coating system comprises an inorganic UV-absorbing material provided in an amount ranging from about 10 wt. % to about 30 wt. % of dry weight of the film after curing of the coating system.

In one embodiment, the coating system comprises an inorganic UV-absorbing material provided in an amount ranging from about 14 wt. % to about 17 wt. % of dry weight of the film after curing of the coating system.

In one embodiment, the polymeric substrate is a polycarbonate based material.

In one aspect, a method of forming a curable silicone hardcoat composition is provided, the method comprising adding a catalyst chosen from catalyst a super base, a salt of a super base, or a combination of two or more thereof to a silicone hardcoat composition comprising a curable silicone material.

In a further aspect, a method of preparing a coated article is provided, the method comprising: applying a silicone hardcoat composition to at least a portion of a surface of an article, the silicone hardcoat composition comprising (a) a curable silicone composition comprising at least one siloxanol resin and at least one colloidal metal oxide, and (b) at least one catalyst chosen from catalyst a super base, a salt of a super base, or a combination of two or more thereof; and curing the silicone hardcoat composition to form a cured coating layer.

These and other aspects and embodiments of the present technology are further understood and described with reference to the following detailed description.

### DETAILED DESCRIPTION

Reference will now be made to exemplary embodiments, examples of which are illustrated in the accompanying drawings. It is to be understood that other embodiments may be utilized and structural and functional changes may be made. Moreover, features of the various embodiments may be combined or altered. As such, the following description is presented by way of illustration only and should not limit in any way the various alternatives and modifications that may be made to the illustrated embodiments. In this disclosure, numerous specific details provide a thorough understanding of the subject disclosure. It should be understood that aspects of this disclosure may be practiced with other embodiments not necessarily including all aspects described herein, etc.

As used herein, the words “example” and “exemplary” means an instance, or illustration. The words “example” or “exemplary” do not indicate a key or preferred aspect or embodiment. The word “or” is intended to be inclusive rather than exclusive, unless context suggests otherwise. As an example, the phrase “A employs B or C,” includes any inclusive permutation (e.g., A employs B; A employs C; or A employs both B and C). As another matter, the articles “a” and “an” are generally intended to mean “one or more,” “at least one,” etc. unless context suggest otherwise.

The present technology provides a coating composition, such as a hardcoat composition, or a system with a cure catalyst that may replace conventional catalysts used for hardcoat formulations. The coating composition or system can exhibit both excellent short term properties such as abrasion resistance and long term properties such as weatherability. Weatherability may be defined as the outdoor service life time of a coated article while maintaining the initial coating properties like transmission, Haze, adhesion, and abrasion resistance. It can be measured through the weathering studies done under accelerated climate conditions involving radiation, temperature, and humidity changes using a Weatherometer.

The coating composition may provide optically clear coatings. The coatings can be used to coat a variety of substrates and can be used, for example, as a topcoat to provide abrasion resistance to certain surfaces.

In an embodiment, the coating compositions comprise a material suitable for forming an abrasion resistant coating and a cure catalyst for curing the composition. The coating composition may be configured to provide a relatively hard coating that may provide abrasion resistance and/or other desirable properties to the substrate. The coating composition may comprise a system that includes an outer (topcoat) layer and an optional primer layer. Depending on the nature of the coating composition and the substrate to be coated, a primer layer may need to be applied over the substrate to promote adhesion of the outer protective coating or topcoat layer. As used herein, the phrase “coating system” may refer to a topcoat layer alone or it may refer to a topcoat layer in combination with the primer layer, as well as any other additional layers that may be included.

The catalyst can be added to the topcoat formulation as desired for a particular purpose or intended application. In one embodiment, the catalyst comprises a super base, a salt of a super base, or a combination of two or more thereof. Generally, the catalyst should be added in an amount that will not affect or impair the physical properties of the coating including, for example, the optical properties of the coating system, but also in an amount effective to provide sufficient weatherability to the coating depending on the performance requirement for the specific application. In one embodiment, the catalyst is provided in an amount ranging from about 1 ppm to about 75 ppm; from about 10 ppm to about 70 ppm; even from about 20 ppm to about 60 ppm. The ppm of catalyst refers to the number of moles of catalyst per total weight of solids (actives) in the formulation. Here, as elsewhere in the specification and claims, numerical values may be combined to form new and unspecified ranges.

The catalyst may be chosen as desired for a particular purpose or intended application. In one embodiment, the catalyst comprises a super base. A super base may be defined as a compound that exhibits basicity significantly higher than that of commonly used amines, such as pyridine or triethylamine. A super base may also be defined to have a pKₐ value above about 11. In embodiments, the super base or salt thereof may have a pKₐ of about 15 or greater, about 20 or greater, about 25 or greater, about 30 or greater, about 35 or greater, even about 40 or greater. In embodiments, the super base may have a pKₐ value of from about 11 to about 45; from about 15 to about 40; from about 20 to about 35; from about 25 to 30. In embodiments, the super base may have a pKₐ value of from about 20 to about 25; in one embodiment from about 22 to about 25. Here as elsewhere in the specification and claims, numerical values may be combined to form new and unspecified ranges.

The super base material or salt thereof may be chosen as desired for a particular purpose or intended application. Examples of suitable materials include, but are not limited to:

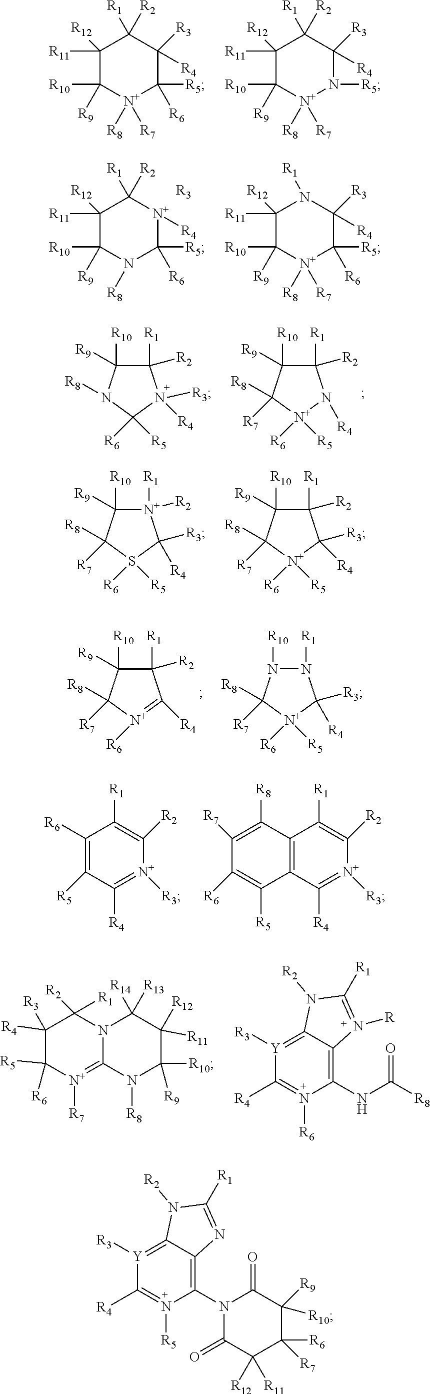

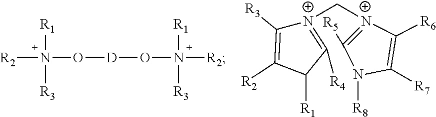

or a combination of two or more thereof, where R₁, R₂, R₃, R₄, R₅, R₆, R₇, R₈, R₉, R₁₀, R₁₁, R₁₂, R₁₃, and R₁₄ are independently chosen from hydrogen, an alkyl, a substituted alkyl, an alkenyl, a substituted alkenyl, an alkynyl, a substituted alkynyl, a carbocycle, a heterocycle, an aryl, or a heteroaryl. X and Y are independently chosen from heteroatoms such as nitrogen, oxygen, sulfur, and phosphorus; and D is chosen from an organo-functional silicon compound having pendent or grafted anionic groups selected from halides, sulfates, alkylsulfates, nitrates, acetates, cyanates, aluminates, borates, tosylates, carboxylates, phosphorous halides, boron halides, organosilicon/silane compound comprising one or more negatively charged hetero atom or combinations of two or more thereof. In one embodiment, R₁-R₁₄ are independently chosen from hydrogen or a C₁-C₄ alkyl. In one embodiment, R₁-R₁₄ are each hydrogen.

A salt of a super base may be formed from any suitable counter ion. In embodiment, salts of super bases may be sulfates, alkylsulfates, tosylates, carboxylates, phosphorous halides, boron halides, organosilicon/silane compounds comprising one or more negatively charged heteroatom, or a combination of two or more thereof. Examples of suitable carboxylic acids to form the salt include, but are not limited to, linear, branched, and/or cyclic carboxylic acids. In one embodiment, the carboxylic acid may be chosen from a C4-C20 linear or branched carboxylic acid. Examples of suitable ions for forming a salt of a super base include, but are not limited to, carboxylic acids, halo ions, etc. In embodiments, the salt is formed from an organic carboxylic acids such as propanoic acid, 2-methyl propanoic acid, butanoic acid, pentanoic acid (valeric acid), hexanoic acid (caproic acid), 2-ethylhexanoic acid, heptanoic acid (enanthic acid), hexanoic acid, octanoic acid (caprylic acid), oleic acid, linoleic acid, linolenic acid, cyclohexanecarboxylic acid, cyclohexylacetic acid, cyclohexenecarboxylic acid, benzoic acid, benzeneacetic acid, propanedioic acid (malonic acid), butanedioic acid (succinic acid), hexanedioic acid (adipic acid), 2-butenedioic acid (maleic acid), lauric acid, stearic acid, myristic acid, palmitic acid, isoanoic acid, versatic acid, lauric acid, or acetic acid stearic acid, myristic acid, palmitic acid, isoanoic acid, or aminoacids. In embodiments, the salt is formed by a chloride or iodide.

In embodiments, the catalyst comprises an imidazole cation. In one embodiment, the imidazole cation is of the formula:

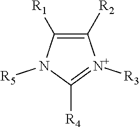

where R₁-R₅ may be as described above. In one embodiment, R₁ and R₂ may be taken to form a 5-10-membered ring, which may comprise one or more heteroatoms. In one embodiment, R₁ and R₂ of the imidazole are taken to be benzene. The imidazole may comprise an aryl group, optionally comprising a heteroatom as part of the R₃ group.

In embodiments, the imidazole compound may comprise two imidazole rings attached to one another via a linking group. In one embodiment, the imidazole is a compound of the formula:

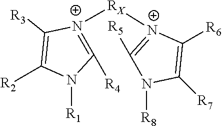

where Rₓ may be a C₁-C₂₀ alkylene, or an aralkylene, where Rₓ optionally comprises comprising one or more heteroatoms, an alkylene, a substituted alkylene, an alkenylene, a substituted alkenylene, an alkynylene, a substituted alkynylene, a carbocycle, a heterocycle, an arylene, or a heteroarylene; and R₁, R₂, R₃, R₄, R₅, R₆, R₇, and R₈ are independently chosen from hydrogen, an alkyl, a substituted alkyl, an alkenyl, a substituted alkenyl, an alkynyl, a substituted alkynyl, a carbocycle, a heterocycle, an aryl, or a heteroaryl, organosilicone compound having pendent or grafted cationic group selected from the group of pyridinium, imidazolium, dialkylimidazolium, trialkylimidazolium, dialkylpyrrolidinium, mono or dialkylpyridinium, trialkylsulfonium, oxazolium, thiazolium, oxadiazolium, triazolium, piperidinium, pyrazolium, pyrimidinium, pyrazinium, triazinium, phosphonium, sulfonium, carbazolium, indolium and their derivatives, quaternary amines and quaternary phosphonium, a heterocyclic compound comprising at least one positively charged heteroatom, organosilicon/silane compound comprising one or more positively charged hetero atom or combinations of two or more thereof. In embodiments, R₁-R₈ are independently chosen from hydrogen or a C₁-C₄ alkyl. It will be appreciated that R₁-R₈ vicinal to one another may be taken to form a ring, which may be saturated or unsaturated. In one embodiment any two of R₁-R₈ vicinal to one another may be taken to form a phenyl. In embodiments, the salt is formed from an organic carboxylic acid such as propanoic acid, 2-methyl propanoic acid, butanoic acid, pentanoic acid (valeric acid), hexanoic acid (caproic acid), 2-ethylhexanoic acid, heptanoic acid (enanthic acid), hexanoic acid, octanoic acid (caprylic acid), oleic acid, linoleic acid, linolenic acid, cyclohexanecarboxylic acid, cyclohexylacetic acid, cyclohexenecarboxylic acid, benzoic acid, benzeneacetic acid, propanedioic acid (malonic acid), butanedioic acid (succinic acid), hexanedioic acid (adipic acid), 2-butenedioic acid (maleic acid), lauric acid, stearic acid, myristic acid, palmitic acid, isoanoic acid, versatic acid, lauric acid, or acetic acid stearic acid, myristic acid, palmitic acid, isoanoic acid, or aminoacids, and anions such as, for example, chloride, iodide, etc.

The imidazole may be selected from compounds having one imidazole ring per molecule, such as, but not limited to, imidazole, 2-methylimidazole, 2-ethyl-4-methylimidazole, 2-methyl-4-ethyl imidazole, 2-undecylimidazole, 2-heptadecylimidazole, 2-phenylimidazole, 2-phenyl-4-methylimidazole, 1-benzyl-2-methylimidazole, 2-ethylimidazole, 2-isopropylimidazole, 2-phenyl-4-benzylimidazole, 1-cyanoethyl-2-methylimidazole, 1-cyanoethyl-2-ethyl-4-methylimidazole, 1-cyanoethyl-2-undecylimidazole, 1-cyanoethyl-2-isopropylimidazole, 1-cyanoethyl-2-phenylimidazole, 2,4-diamino-6-[2′-methylimidazolyl-(1)′]-ethyl-s-triazine, 2,4-diamino-6-[2′-ethyl-4-methylimidazolyl-(1)′]-ethyl-s-triazine, 2,4-diamino-6-[2′-undecylimidazolyl-(1)′]-ethyl-s-triazine, 2-methyl-imidazo-lium-isocyanuric acid adduct, 2-phenylimidazolium-isocyanuric acid adduct, 1-aminoethyl-2-methylimidazole, 2-phenyl-4,5-dihydroxymethylimidazole, 2-phenyl-4-methyl-5-hydroxymethylimidazole, 2-phenyl-4-benzyl-5-hydroxymethylimidazole, or combinations of two or more thereof. The imidazole may be selected from compounds containing 2 or more imidazole rings per molecule which are obtained by dehydrating hydroxymethyl-containing imidazole compounds such as 2-phenyl-4,5-dihydroxymethylimidazole, 2-phenyl-4-methyl-5-hydroxymethylimidazole and 2-phenyl-4-benzyl-5-hydroxy-methylimidazole, or combinations of two or more thereof; and condensing them with formaldehyde, e.g., 4,4′-methylene-bis-(2-ethyl-5-methylimidazole).

Still other examples of suitable imidazoles include, but are not limited to:

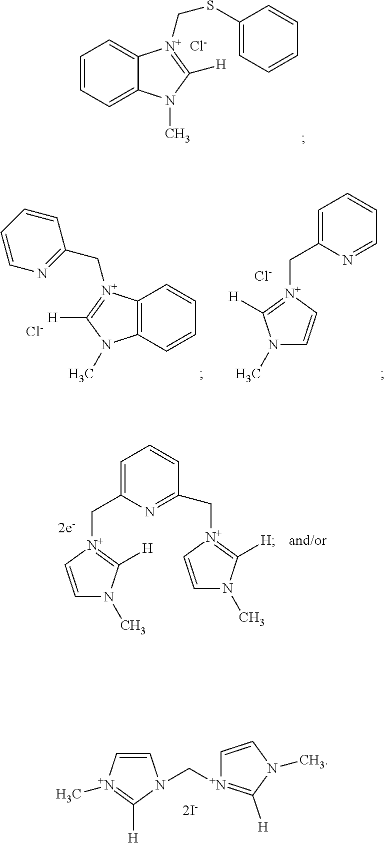

In embodiments, the catalyst may be a super base chosen from an amidine, a guanidine, a multicyclic polyamine, a phosphazene derivative, etc., or a combination of two or more thereof.

Amidines may be defined as amine compounds which have an imine function adjacent to the alpha carbon. Structurally these correspond to amine equivalents of carboxylic esters. The amidine may be a compound of the formula:

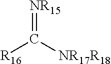

where R₁₅-R₁₈ are independently chosen from hydrogen and/or a C1-C16 alkyl substituents that may be linear, branched, cyclic or aromatic. Further the substituents R₁₅-R₁₈ may be unsaturated, halogenated, or carry a specific functionality such as hydroxyl, ether, amine, cyano, or nitro functional groups. The alkyl substituents R₁₅-R₁₈ may also form bicyclic structures, where an increased ring strain may lead to stronger basicity. Examples of cyclic amidines include, but are not limited to, 1,5-diazabicyclo[4.3.0]non-5-ene (DBN), 2,8,9-triisopropyl-2,5,8,9-tetraaza-1-phorosphabicylo[3,3,3]undecane (TITAPBU), 3,3,6,9,9-pentamethyl-2,10-diazabicyclo-[4.4.0]dec-1-ene,1,8-diazabicyclo[5.4.0]-undec-7-ene (DBU). DBU is one of the strongest amidine derivatives.

Guanidines may be classified as amines comprising two imine functions adjacent to the a-carbon. These may correspond to amine equivalents of ortho esters and show the strongest Bronsted basicity among amine derivatives. The basicity of guanidine is close to that of a hydroxyl-ion, which is one of the strongest bases in aqueous chemistry. The guanidine may be a compound of the formula:

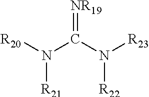

where each occurrence R₁₉-R₂₃ are independently chosen from hydrogen and/or a C1-C16 alkyl substituent that may be linear, branched, cyclic or aromatic. Further the substituents R₁₉-R₂₃ may be unsaturated, halogenated, or carry a specific functionality such as hydroxyl, ether, amine, cyano, or nitro functional groups. The alkyl substituents R₁₉-R₂₃ may also comprise bicyclic structures, where an increased ring strain may lead to stronger basicity. Examples of guanidines include, but are not limited to, 1,5,7-triazabicyclo[4.4.0]dec-5-ene (TBD), N-methyl-1,5,7-triazabicyclo[4.4.0]dec-5-ene (MTBD), N,N,N′,N′-tetramethylguanidine (TMG), or N,N,N′,N′,N″-pentamethylguanidine.

Phosphazenes are organic super bases comprising a phosphorus atom bonded to four nitrogen functions of three amine substituents and one imine substituent. Phosphazenes are classified as Pₙ bases, where n denotes the number of phosphorus atoms in the molecule. The basicity of phosphazenes increase with an increasing amount of phosphorous atoms in the molecule. A P₄ base is considered to have a basicity parallel to organo lithium compounds. The phosphazene may be a compound of the formula:

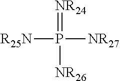

where R₂₄-R₂₇ are independently chosen from hydrogen and/or a C1-C16 alkyl substituent that may be linear, branched, cyclic or aromatic. Further these alkyl substituents R₂₄-R₂₇ may be unsaturated, halogenated or carry a specific functionality such as hydroxyl, ether, amine, cyano, or nitro functions. The alkyl substituents R₂₄-R₂₇ may be the same or mixtures of various combinations.

The super base may also be an azaphosphatrane. The azaphosphatrane may be chosen from a compound of the following formula:

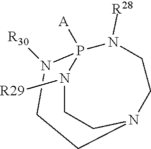

where R₂₈, R₂₉, and R₃₀ are independently chosen from hydrogen, a linear or branched alkyl comprising 1 to 10 carbon atoms, and an aromatic group comprising 6 to 12 carbon atoms, and a substituted phosphorous group with or without nitrogen; A is null or chosen from hydrogen, R₃₁, or (R₃₂R₃₃P—N═)ₜ, where R₃₁, R₃₂, and R₃₃ are independently chosen from hydrogen, a linear or branched alkyl comprising 1 to 10 carbon atoms, and an aromatic group comprising 6 to 12 carbon atoms; and t is 1 to 10. Suitable alkyl groups include, but are not limited to, methyl, ethyl, propyl, butyl, pentyl, hexyl, octyl, isopropyl, isobutyl, etc. Suitable aromatic groups include, but are not limited to phenyl, benzyl, naphthyl, etc.

In one embodiment, the azaphosphatrane compound can be chosen from the following formulae:

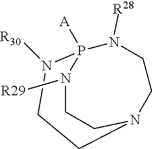

where A is hydrogen;

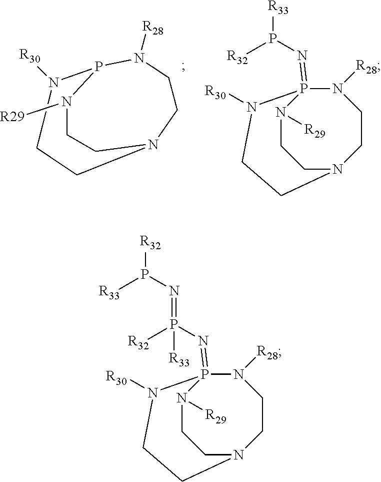

or combinations of two or more thereof, where R₂₈-R₃₀ can be as described above. In one embodiment, the azaphosphatrane material is chosen from a compound above where R₃₁, R₃₂, and R₃₃ are chosen from methyl, isopropyl, isobutyl, or a combination of two or more thereof.

It will be appreciated that one or more different azaphosphatrane materials can be used as the catalyst material.

Still other suitable catalysts include phosphonium compounds; phosphorous imines, and ylides.

The catalyst can be added to the coating composition directly or can be dissolved in a solvent or other suitable carrier. The solvent may be a polar and/or non-polar solvent such as methanol, ethanol, n-butanol, t-butanol, n-octanol, n-decanol, 1-methoxy-2-propanol, isopropyl alcohol, ethylene glycol, tetrahydrofuran, dioxane, diethyl ether, dibutyl ether, bis(2-methoxyethyl)ether, 1,2-dimethoxyethane, acetonitrile, benzonitrile, methylethyl ketone, and propylene carbonate.

The coating compositions may include UV absorbers. The UV absorbers may be inorganic, organic, or a combination of two or more thereof. Examples of suitable inorganic UV-absorbing material include, but are not limited to, cerium oxide, titanium oxide, zinc oxide, iron oxide or a combination of two or more thereof. Generally, the inorganic material should be added in an amount that will not affect or impair the physical properties of the coating including, for example, the optical properties of the coating system. In one embodiment, the inorganic material is provided in an amount ranging from about 1 wt. % to about 50 wt. %; from about 7 wt. % to about 40 wt. %; from about 10 to about 30 wt. %; even from about 14 to about 17 wt. % based on the dry weight of the film after curing of the coating. Here, as elsewhere in the specification and claims, numerical values may be combined to form new and unspecified ranges.

Examples of suitable organic UV absorbers, include, but are not limited to, those capable of co-condensing with silanes. Such UV absorbers are disclosed in U.S. Pat. Nos. 4,863,520, 4,374,674, 4,680,232, and 5,391,795 which are herein incorporated by reference in their entireties. Specific examples include 4-[gamma-(trimethoxysilyl) propoxyl]-2-hydroxy benzophenone and 4-[gamma-(triethoxysilyl) propoxyl]-2-hydroxy benzophenone and 4,6-dibenzoyl-2-(3-triethoxysilylpropyl) resorcinol. When the UV absorbers that are capable of co-condensing with silanes are used, the UV absorber should co-condense with other reacting species by thoroughly mixing the coating composition before applying it to a substrate. Co-condensing the UV absorber prevents coating performance loss caused by the leaching of free UV absorbers to the environment during weathering.

The coating compositions may include one or more other materials or additives to provide the coating with desired properties for a particular purpose or intended application. For example, the composition may also include additives such as hindered amine light stabilizers, antioxidants, dyes, flow modifiers, leveling agents, and surfactants. Surfactants are commonly added as a flow modifier/leveling agent in coating compositions. Examples of suitable surfactants include, but are not limited to, fluorinated surfactants such as FLUORAD™ from 3M Company of St. Paul, Minn., and silicone polyethers under the designation Silwet® and CoatOSil® available from Momentive Performance Materials, Inc. of Waterford, N.Y. and polyether-polysiloxane copolymers such as BYK®-331 manufactured by BYK®-Chemie. Suitable antioxidants include, but are not limited to, hindered phenols (e.g., IRGANOX® 1010 from Ciba Specialty Chemicals).

In an embodiment, the topcoat coating composition is chosen, in one embodiment, from a material suitable for providing a topcoat. The coating composition is a silicone topcoat. Non-limiting examples of silicone coatings that provide a Hardcoat composition are dispersions of a siloxanol resin and a colloidal metal oxide dispersion. In one embodiment, the siloxanol resin is derived from a partial condensate of a silanol and an alkoxysilane. Examples of suitable colloidal metal oxides include, but are not limited to, colloidal silica, colloidal cerium oxide, or a combination of two or more thereof.

Siloxanol resin based colloidal silica dispersions are described, for example, in U.S. patent application Ser. No. 13/036,348, U.S. Pat. No. 8,637,157, U.S. Pat. No. 5,411,807, and U.S. Pat. No. 5,349,002, the entire disclosures of which are incorporated herein by reference in their entirety.

Siloxanol resin based colloidal silica dispersions are known in the art. Generally, these compositions have a dispersion of colloidal silica in an aliphatic alcohol/water solution of the partial condensate of an organoalkoxysilane. Suitable organoalkoxysilanes include those of the formula (R)aSi(OR′)4-a, where R is a C1-C6 monovalent hydrocarbon radical, R′ is R or hydrogen, and a is a whole number equal to 0 to 2 inclusive. In one embodiment, the organoalkoxysilane is an alkyltrialkoxysilane, which can be, but is not limited to, methyltrimethoxysilane. Other examples of suitable organoalkoxysilanes for the resin include, but are not limited to, tetraethoxysilane, ethyltriethoxysilane, diethyldiethoxysilane, tetramethoxysilane, methyltrimethoxysilane, dimethyldimethyoxysilane, etc. Aqueous colloidal silica dispersions generally have a particle size in the range of about 5 to about 150 nanometers in diameter. These silica dispersions are prepared by methods well-known in the art and are commercially available. Depending upon the percent solids desired in the final coating composition, additional alcohol, water, or a water-miscible solvent can be added. Generally, the solvent system should contain from about 20 to about 75 weight percent alcohol to ensure solubility of the siloxanol formed by the condensation of the silanol. If desired, a minor amount of an additional water-miscible polar solvent can be added to the water-alcohol solvent system. The composition is allowed to age for a short period of time to ensure formation of the partial condensate of the silanol, i.e., the siloxanol. Upon generating the hydroxyl substituents of these silanols, a condensation reaction begins to form silicon-oxygen-silicon bonds. This condensation reaction is not exhaustive. The siloxanes produced retain a quantity of silicon-bonded hydroxy groups, which is why the polymer is soluble in the water-alcohol solvent mixture. This soluble partial condensate can be characterized as a siloxanol polymer having silicon-bonded hydroxyl groups and —SiO— repeating units. More particularly, not all of the alkoxy groups of the organosilane are condensed to siloxane bonds. The degree of condensation is characterized by the T³/T² ratio wherein T³ represents the number of silcon atoms in the siloxanol polymer that have three siloxane bonds, having condensed with three other alkoxysilane or silanol species. T² represents the number of silicon atoms in the siloxanol polymer that have two siloxane bonds, having condensed with other with two other alkoxysilane or silanol species and one alkoxy or hydroxy group remaining. The T³/T² ratio can range from 0 (no condensation) to ∞ (complete condensation). The T³/T² for siloxanol resin based coating solutions is preferably 0.2 to 3.0, and more preferably from about 0.6 to about 2.5.

Examples of aqueous/organic solvent borne siloxanol resin/colloidal silica dispersions can be found in U.S. Pat. No. 3,986,997 to Clark which describes acidic dispersions of colloidal silica and hydroxylated silsesquioxane in an alcohol-water medium with a pH of about 3-6. Also, U.S. Pat. No. 4,177,315 to Ubersax discloses a coating composition comprising from about 5 to 50 weight percent solids comprising from about 10 to 70 weight percent silica and about 90 to 30 weight percent of a partially polymerized organic silanol of the general formula RSi(OH)₃, wherein R is selected from methyl and up to about 40% of a radical selected from the group consisting of vinyl, phenyl, gamma-glycidoxypropyl, and gamma-methacryloxypropyl, and about from 95 to 50 weight percent solvent, the solvent comprising about from 10 to 90 weight percent water and about from 90 to 10 weight percent lower aliphatic alcohol, the coating composition having a pH of greater than about 6.2 and less than about 6.5. U.S. Pat. No. 4,476,281 to Vaughn describes hardcoat composition having a pH from 7.1-7.8. In another example, U.S. Pat. No. 4,239,798 to Olson et al. discloses a thermoset, silica-filled, organopolysiloxane top coat, which is the condensation product of a silanol of the formula RSi(OH)₃ in which R is selected from the group consisting of alkyl radicals of 1 to 3 carbon atoms, the vinyl radical, the 3,3,3-trifluoropropyl radical, the gamma-glycidoxypropyl radical and the gamma-methacryloxypropyl radical, at least about 70 weight percent of the silanol being CH₃Si(OH)₃. The content of the foregoing patents are herein incorporated by reference.

The siloxanol resin/colloidal silica dispersions described herein can contain partial condensates of both organotrialkoxysilanes and diorganodialkoxysilanes; and can be prepared with suitable organic solvents, such as, for example, 1 to 4 carbon alkanol, such as methanol, ethanol, propanol, isopropanol, butanol; glycols and glycol ethers, such as propyleneglycolmethyl ether and the like and mixtures thereof.

Examples of suitable commercial silicone coating materials include, but are not limited to, SilFORT™ AS4700, SilFORT™ PHC 587, SilFORT™ AS4000, SilFORT™ SHC2050 available from Momentive Performance Materials Inc., SILVUE™ 121, SILVUE™ 339, SILVUE™ MP100, CrystalCoat™ CC-6000 available from SDC Technologies, and HI-GARD™ 1080 available from PPG, etc.

In one embodiment, the silicone hardcoat system comprises from about 10% to about 50% by weight of solids. In one embodiment, the silicone hardcoat system comprises from about 15% to about 45% by weight of solids. In one embodiment, the silicone hardcoat system comprises from about 20% to about 30% by weight of solids.

The coating comprising the present catalysts may be applied to a substrate as desired for a particular purpose or intended application. The coating may be applied directly to the surface of a substrate of interest. Alternatively, as may be desired or needed depending on the substrate that is being coated, a primer may be disposed on the surface of the substrate, and the coating may be disposed over the primer layer. The number of coating layers or primer layers may also be selected as desired for a particular purpose or intended application. For example, it may be possible to employ a single coating layer, two or more coating layers, three or more coating layers, etc. In one embodiment, the hardcoat may be formed by 1 to 5 coating layers, 2-4 coating layers, or 3 coating layers. Multiple coating layers may be formed by applying a first coating layer, sufficiently drying the coating, and forming a subsequent coating layer over the adjacent coating layer. This may be done as many times as required to provide the desired number of coating layers. It will be appreciated that the coating layers may have the same or different compositions from one another. Similarly, it is within the scope of the present technology that multiple primer layers may be employed to promote adhesion of a coating layer to a substrate.

The coating can be applied to any suitable substrate. Examples of suitable substrates include, but are not limited to, organic polymeric materials such as acrylic polymers, e.g., poly(methylmethacrylate), polyamides, polyimides, acrylonitrile-styrene copolymer, styrene-acrylonitrile-butadiene terpolymers, polyvinyl chloride, polyethylene, polycarbonates, copolycarbonates, high-heat polycarbonates, and any other suitable material.

In applications comprising a primer layer or coating, the primer composition comprises a material suitable for facilitating adhesion of the topcoat material to the substrate. The primer material is not particularly limited, and may be chosen from any suitable primer material. In one embodiment, the primer is chosen from homo and copolymers of alkyl acrylates, polyurethanes, polycarbonates, polyvinylpyrrolidone, polyvinylbutyrals, poly(ethylene terephthalate), poly(butylene terephthalate), a urethane hexaacrylate, a pentaerythritol triacrylate, a polyvinylpyrrolidone, a polyvinylbutyral, a poly(ethylene terephthalate), poly(butylene terephthalate), or a combination of two or more thereof. In one embodiment, the primer may be polymethylmethacrylate. Examples of suitable primer coating materials include, but are not limited to, SilFORT™ SHP470, SilFORT™ SHP470FT-2050, SilFORT™ SHP401, available from Momentive Performance Materials Inc. and CrystalCoat™ PR-660, available from SDC Technologies, etc.

The primer coating may be coated onto a substrate by flow coat, dip coat, spin coat, spray coat or any other methods known to a person skilled in the field, it is allowed to dry by removal of any solvents, for example by evaporation, thereby leaving a dry coating. The primer may subsequently be cured. Additionally, a topcoat (e.g., a hardcoat layer) may be applied on top of the dried primer layer by flow coat, dip coat, spin coat or any other methods known to a person skilled in the field. Optionally, a topcoat layer may be directly applied to the substrate without a primer layer. The topcoat may subsequently be cured.

The following examples illustrate embodiments of materials in accordance with the disclosed technology. The examples are intended to illustrate aspects and embodiments of the disclosed technology, and are not intended to limit the claims or disclosure to such specific embodiments.

### EXAMPLES

### Example S-1

### Preparation of Cerium Oxide Containing Silicone Hardcoat Sol

Cerium oxide containing silicone hardcoat resin solutions were prepared by hydrolysis of methyltrimethoxysilane (MTMS) in a solution of colloidal cerium oxide (Sigma Aldrich, 20 wt % Ceria, 2.5 wt % acetic acid). A small glass bottle was charged with colloidal cerium oxide solution. MTMS was added to the chilled cerium oxide solution over approximately 20 minutes. The mixture was allowed to stand at room temperature and was stirred for several hours. Next, 1-methoxy-2-propanol (MP) was mixed in, and the reaction was allowed to stand at room temperature for several more days. The reaction mixture was then further diluted with isopropanol (IPA) and the flow control additive BYK® 302 polyether modified polydimethylsiloxane (available from Byk-Chemie GmbH) was added. Table 1 illustrates an example formulation of the cerium oxide containing silicone hardcoat sol. Final solid content of the formulation was calculated as 20.1 wt %.

TABLE 1
Charges for the preparation of ceria oxide containing
silicone hardcoat sol example S-1.

| Material | Charge (g) |
|---|---|
| MTMS | 93.0 |
| Colloidal CeO₂ (20%, 2.5% AcOH) | 76.2 |
| MP | 44.0 |
| IPA | 90.8 |
| BYK ® 302 polyether modified | 0.12 |
| polydimethylsiloxane | |

### Example S-2

### Preparation of Cerium Oxide Containing Silicone Hardcoat Sol

Cerium oxide containing Silicone Hardcoat resin solutions were prepared by following the same procedure as in Example S-1 except that the charges are as indicated in Table 2. Final solid concentration of the formulation was calculated as 21.6 wt %.

TABLE 2
Charges for the preparation of ceria oxide containing
silicone hardcoat sol example S-2.

| Material | Charge (g) |
|---|---|
| MTMS | 317.75 |
| Colloidal CeO₂ (20%, 2.5% AcOH) | 159.75 |
| MP | 118.50 |
| IPA | 276.75 |
| BYK ® 302 polyether modified | 0.176 |
| polydimethylsiloxane | |

### Example S-3

### Alternative Preparation of Cerium Oxide Containing Silicone Hardcoat Sol

A cerium oxide-siloxanol hydrolysate was prepared by charging the cerium oxide sol (Sigma Aldrich, 20 wt. % solids, 2.5 wt % acetic acid stabilized, aqueous) to an Erlenmeyer flask then cooling in an ice bath to <10° C. MTMS was then added to the cool CeO₂ sol over 30 minutes while stirring the mixture and maintaining the temperature between 10-15° C. The resulting hydrolysate was allowed to warm to room temperature and stir for an additional 16 hours. The hydrolysate was then diluted by adding MP and IPA and allowed to stand for three days at room temperature to age. The pH of the hydrolysate was then adjusted to 5.1 by adding NH₃ solution. The flow control agent BYK® 331 polyether modified polydimethylsiloxane (available from Byk-Chemie GmbH) was then added to the Cerium Oxide-siloxanol hydrolyzate mixture. Table 3 shows the charges used to formulate the cerium oxide siloxanol coating sol, Example S-3. This formulation had a measured solids concentration of 25.8 wt %. The formulation was further aged prior to final formulation with catalyst.

TABLE 3
Charges for the alternative preparation of ceria oxide
containing silicone hardcoat sol example S-3.

| Material | Charge (g) |
|---|---|
| Colloidal CeO₂ (20%, 2.5% AcOH) | 400.33 |
| MTMS | 852.26 |
| MP | 382.00 |
| IPA | 362.29 |
| 14.6 wt % ammonia (in water) | 4.41 |
| BYK ® 331 polyether modified | 0.40 |
| polydimethylsiloxane | |

### Example S-4

### Preparation of Silicone Hardcoat Sol Containing Both Cerium Oxide and Colloidal Silica

A cerium oxide-siloxanol hydrolysate was prepared by charging the cerium oxide sol (Sigma Aldrich, 20 Wt % solids, 2.5 wt % acetic acid stabilized, aqueous) to an Erlenmeyer flask then cooling in an ice bath to <10° C. MTMS was then added to the cool CeO₂ sol over 30 minutes while stirring the mixture and maintaining the temperature between 10-15° C. The resulting hydrolysate was allowed to warm to room temperature and stir for an additional 16 hours. The hydrolysate was then diluted by adding MP. The hydrolysate was aged by allowing it to stand for three days at room temperature.

A colloidal silica-siloxanol hydrolysate was prepared by charging the colloidal silica sol (Nalco 1034A, 34.7 Wt % solids, aqueous) to an Erlenmeyer flask then cooling in an ice bath to <10° C. MTMS was then added to the cool SiO₂ sol over 30 minutes while stirring the mixture. The resulting hydrolysate was allowed to warm to room temperature and stir for an additional 16 hours. The hydrolysate was then diluted by adding iso-propanol. The hydrolysate was aged by allowing it to stand for three days at room temperature.

The cerium oxide containing hydrolysate and colloidal silica containing hydrolysate were then combined and stirred to completely mix them. The pH of the combined hydrolysate was then adjusted to 5.1 by adding NH₃ solution. To the CeO₂/SiO₂ siloxanol hydrolysate mixture was then added the flow control agent BYK® 331 polyether modified polydimethylsiloxane. Table 4 shows the charges used to formulate the mixed cerium oxide-colloidal silica siloxanol coating solution, this formulation had a measured solids concentration of 25.6 wt %. The hydrolysate was further aged prior to final formulation with catalyst.

TABLE 4
Charges for ceria/silica containing silicone hardcoat sol.

| Material | Charge (g) |
|---|---|
| Cerium oxide siloxanol sol | |
| 20% Cerium Oxide Sol | 400.85 |
| MTMS | 419.15 |
| MP | 380.00 |
| Colloidal Silica siloxanol sol | |
| 34.7% Colloidal Silica Sol | 187.31 |
| MTMS | 301.35 |
| IPA | 311.34 |
| Final coating sol | |
| Cerium Oxide siloxanol | 1200.00 |
| Colloidal Silica siloxanol | 800.00 |
| 14.6 wt % ammonia (in water) | 4.42 |
| BYK ® 331 polyether modified | 0.40 |
| polydimethylsiloxane | |

### Example S-5

### Preparation of Silicone Hardcoat Sol Containing Colloidal Silica and 4-[γ-(triethoxysilyl) propoxyl]-2-hydroxy benzophenone

MTMS and acetic acid were mixed together at a temperature of 10-15° C. followed by the addition of Colloidal silica sol (Ludox® AS40 colloidal silica, 40 Wt % solids, ammonium stabilized, available from W.R. Grace & Co.) and additional water, while maintaining the temperature between 10-15° C. The solution was mixed for 12-20 hours and the hydrolysate was diluted by adding IPA and n-butanol (NBA) followed by the additional lot of acetic acid. 4-[γ-(triethoxysilyl) propoxyl]-2-hydroxy benzophenone (SHBP) was added to the mixture and stirred further for several hours. The flow control agent BYK® 302 was added to the mixture and the hydrolysate was aged by allowing it to stand at room temperature over several days. This formulation had a measured solids concentration of 20%. Table 5 show the charges used to formulate the silicone Hardcoat sol.

TABLE 5
Charges for silicone hardcoat sol containing colloidal silica and
4-[γ-(triethoxysilyl) propoxyl]-2-hydroxy benzophenone.

| Material | Charge (g) |
|---|---|
| MTMS | 231.7 |
| Acetic acid | 5.64 |
| Ludox ® AS40 colloidal silica (40% | 143.15 |
| Silica sol) | |
| Water | 43.15 |
| IPA | 148.90 |
| NBA | 148.90 |
| Acetic Acid (2^{nd} lot) | 7.01 |
| SHBP | 21.15 |
| BYK ® 302 polyether modified | 0.15 |
| polydimethylsiloxane | |

### Example S-6

### Preparation of Silicone Hardcoat Sol Containing Colloidal Silica and 4,6-dibenzoyl-2-(3-triethoxysilylpropyl) resorcinol

MTMS and acetic acid were mixed together followed by the addition of colloidal silica sol (Ludox® AS40 colloidal silica, 40 wt % solids) and additional deionized water while maintaining the temperature around 10-15° C. The solution was mixed for 12-20 hours, and the hydrolysate was then diluted by adding IPA and NPA followed by the additional lot of acetic acid. To the diluted hydrolysate was then added 4,6-dibenzoyl-2-(3-triethoxysilylpropyl) resorcinol (SDBR) as a 32 wt % solution in MP and the mixture was then allowed to stir for several hours followed by the addition of BYK302. The hydrolysate was then aged at room temperature (20° C.) for 50-75 days. Table 6 shows the charges used to formulate the silicone hardcoat sol. This formulation had a measured solids concentration of 24.7%.

TABLE 6
Charges for silicone hardcoat sol containing colloidal silica
and 4,6-dibenzoyl-2-(3-triethoxysilylpropyl) resorcinol.

| Material | Charge (g) |
|---|---|
| MTMS | 564.0 |
| Acetic Acid | 13.5 |
| Ludox ® AS40 colloidal silica | 226.6 |
| Deionized Water | 197.6 |
| IPA | 260.6 |
| NBA | 262.1 |
| Acetic Acid | 30.0 |
| SDBR (32% solution in MP) | 45.2 |
| BYK ® 302 polyether modified | 0.30 |
| polydimethylsiloxane | |

### Example S-7

### Preparation of Water Washed Formulation of Silicone Hardcoat Sol Containing Colloidal Silica and 4,6-dibenzoyl-2-(3-triethoxysilylpropyl) resorcinol

MTMS and acetic acid were mixed together at a temperature of 10-15° C. followed by the addition of Colloidal silica sol (Ludox® AS40 colloidal silica, 40 wt % solids) and additional deionized water over a 20 minute period. The resulting hydrolysate was allowed to warm to room temperature and stir for 12-20 hours. The hydrolysate was then diluted by adding IPA and NBA followed by the addition of a second portion of acetic acid. To the diluted hydrolysate was then added SDBR as a 32 wt % solution in MP and the reaction mixture was allowed to stir for several hours. The hydrolysate was then aged at room temperature for 30-50 days. The hydrolysate was then mixed with an equal weight of deionized water and mixed vigorously. The water-hydrolysate mixture was then transferred to a separatory funnel and allowed to stand for 60 minutes after which two layers had formed. The bottom layer (silicone resin phase) was drawn off and separated from the top layer (aqueous phase). The silicone resin phase had a measured solids concentration of 54.4%. The organic/silicone phase was then diluted with a mixture of methanol, IPA, NBA, acetic acid, and MP. The mixture was then aged further for 30-50 days at room temperature (20° C.) after which the flow control agent BYK® 302 polyether modified polydimethylsiloxane was added. Table 7 shows the charges used to formulate the silicone hardcoat sol. This formulation had a measured solids concentration of 25.4%.

TABLE 7
Charges for water washed formulation of silicone
hardcoat sol containing colloidal silica and 4,6-
dibenzoyl-2-(3-triethoxysilylpropyl) resorcinol.

| Material | Charge (g) |
|---|---|
| MTMS | 705.4 |
| Acetic Acid | 16.8 |
| Ludox ® AS40 colloidal silica | 283.4 |
| Deionized Water (hydrolysis) | 247.2 |
| IPA | 326.0 |
| NBA | 327.9 |
| Acetic Acid | 37.5 |
| SDBR (32% solution in MP) | 56.5 |
| Deionized Water (water wash) | 2002.0 |
| Silicone Resin Phase (recovered) | 772.2 |
| Methanol (dilution) | 28.0 |
| IPA (dilution) | 396.3 |
| Acetic Acid (dilution) | 46.5 |
| NBA (dilution) | 363.2 |
| MP (dilution) | 27.5 |
| BYK ® 302 polyether modified | 0.38 |
| polydimethylsiloxane | |

### Example S-8

### Preparation of Formulation of Primerless Silicone Hardcoat Sol Containing Colloidal Silica and 4-[γ-(triethoxysilyl) propoxyl]-2-hydroxy benzophenone

MTMS and acetic acid were mixed together at a temperature of 10-15° C. followed by the addition of Colloidal silica sol (Ludox® AS40 colloidal silica, 40 wt % solids) and additional deionized water over a 20 minute period to the MTMS-acetic acid mixture. After 10-25 hours, the hydrolysate was then diluted by adding IPA and NBA followed by the addition of a second portion of acetic acid. To the diluted hydrolysate was then added SHBP and the reaction mixture was allowed to stir for several hours and allowed to age at room temperature (20° C.) for 50-60 several days. Volatile solvent was then removed by vacuum distillation until the hydrolysate residue (in distillation pot) reached a solids concentration of 34.3%. The concentrated hydrolysate was diluted with IPA and NBA and then an acrylic polyol (Jonacryl® 587 acrylic polyol, BASF, Florham Park, N.J.) and BYK® 302 polyether modified polydimethylsiloxane were dissolved into the hydrolysate solution. The final solids concentration was measured at 25.0%. Table 8 shows the charges used to formulate the silicone hardcoat sol.

TABLE 8
Charges for primerless silicone hardcoat sol containing colloidal silica
and 4-[γ-(triethoxysilyl) propoxyl]-2-hydroxy benzophenone.

| Material | Charge (g) |
|---|---|
| MTMS | 1098.1 |
| Acetic Acid | 18.2 |
| Ludox ® AS40 colloidal silica | 677.1 |
| Deionized Water | 202.1 |
| IPA | 698.7 |
| NBA | 777.5 |
| SHBP | 94.4 |
| Stripped Hydrolyzate (yield) | 1339.7 |
| IPA (dilution) | 248.0 |
| NBA (dilution) | 248.0 |
| Acrylic Polyol | 15.8 |
| BYK ® 302 polyether modified | 0.72 |
| polydimethylsiloxane | |

The catalysts in Table 9 were used to formulate the final coating solutions shown in Tables 10-12. In each case, the silicone hardcoat sol was charged to a glass bottle and then the catalyst was added. The mixture was then agitated to completely dissolve the catalyst.

TABLE 9
Catalysts Used in coating examples.

| Catalyst | |
|---|---|
| ID | Catalyst |
| A | 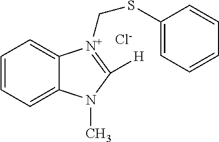 [SMILES: Cn1c[n+](CSc2ccccc2)c2ccccc21 ; [Cl-]] |
| | 1-methyl-3-((phenylthio)methyl)-1H- |
| | benzo[d]imidazole-3-ium chloride |
| | (MPMBIC) |
| B | 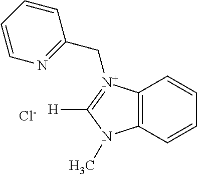 [SMILES: Cn1c[n+](Cc2ccccn2)c2ccccc21 ; [Cl-]] |
| | 1-methyl-3-(pyridin-2-ylmethyl)-1H- |
| | benzo[d]imidazol-3-ium chloride |
| | (MPyMBIC) |
| C | 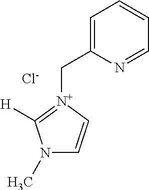 |
| | 1-methyl-3-(pyridin-2-ylmethyl)- |
| | 1H-imidazol-3-ium chloride |
| | (MPyMIC) |
| D | 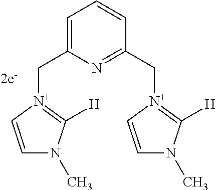 |
| | 3,3′-(pyridine-2,6-diylbis(methylene)) |
| | bis(1-methyl-1H-imidazol-3-ium) |
| | chloride (PyBisIC) |
| E | 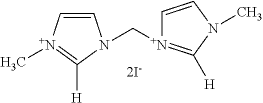 |
| | 1-methyl-3-((3-methyl-1H-imidazol- |
| | 3-ium-1-y1)methyl)-1H-imidazol-3- |
| | ium iodide (MIMII) |
| F | Tetrabutylammonium Acetate (TBAA) |
| G | 2,8,9-Trimethy1-2,5,8,9-tetraaza-1- |
| | phosphabicyclo[3,3,3]undecane (TMTPU) |
| H | 1,5,7-Triazabicyclo[4.4.0]dec-5-ene (TBD) |
| J | 1,8-Diazabicycloundec-7-ene acetic acid |
| | (DBU-Ac) |
| K | 1,8-Diazabicycloundec-7-ene Versatic acid |
| | (DBU-Va) |
| M | 1,5,7-triazabicyclo[4,4,0]dec-5-ene acetic acid |
| | (TBD-Ac) |
| N | 1,5,7-triazabicyclo[4,4,0]dec-5-ene |
| | Versatic acid (TBD-Va) |
| P | 2,8,9-Triisopropy1-2,5,8,9-tetraaza-1- |
| | phosphabicyclo[3,3,3]undecane Versatic |
| | acid (TIPTPU-Va) |
| Q | 2,8,9-Triisopropyl-2,5,8,9-tetraaza-1- |
| | phosphabicyclo[3,3,3]undecane (TIPTPU) |

### Examples 1-32 and Comparative Examples CE-1 to CE-16

The formulations made from examples S-1 through S-8 were then applied to primed polycarbonate substrates and formulations made from S-9 were applied to unprimed polycarbonate substrates.

TABLE 10
Examples and comparative examples coated onto polycarbonate
substrates primed with polymethylmethacrylate.

| | Silicone | | | | |
|---|---|---|---|---|---|
| | Coating Sol | | Catalyst | | |
| Example | ID | Charge (g) | ID | Type | Charge (g) |
| 1 | S-1 | 25.35 | A | 100% (Solid) | 0.0325 |
| 2 | S-1 | 25.35 | A | 100% (Solid) | 0.0649 |
| 3 | S-1 | 25.35 | B | 100% (Solid) | 0.0330 |
| 4 | S-1 | 25.35 | B | 100% (Solid) | 0.0660 |
| 5 | S-1 | 25.35 | C | 100% (Solid) | 0.0267 |
| 6 | S-1 | 25.35 | C | 100% (Solid) | 0.0533 |
| 7 | S-1 | 25.35 | D | 100% (Solid) | 0.0433 |
| 8 | S-1 | 25.35 | D | 100% (Solid) | 0.0865 |
| 9 | S-1 | 25.35 | E | 100% (Solid) | 0.0549 |
| 10 | S-1 | 25.35 | E | 100% (Solid) | 0.1099 |
| CE-1 | S-2 | 34.8 | F | 39.9 wt % (in water) | 0.0513 |
| CE-2 | S-2 | 34.8 | F | 39.9 wt % (in water) | 0.2561 |
| CE-3 | S-2 | 34.8 | F | 39.9 wt % (in water) | 0.3131 |
| CE-4 | S-2 | 34.8 | F | 39.9 wt % (in water) | 0.3699 |
| 11 | S-2 | 34.8 | G | 100% (Solid) | 0.0147 |
| 12 | S-2 | 34.8 | G | 100% (Solid) | 0.0345 |
| 13 | S-2 | 34.8 | G | 100% (Solid) | 0.0407 |
| 14 | S-2 | 34.8 | G | 100% (Solid) | 0.0570 |
| 15 | S-2 | 34.8 | H | 100% (Solid) | 0.0052 |
| 16 | S-2 | 34.8 | H | 100% (Solid) | 0.0105 |
| 17 | S-2 | 34.8 | H | 100% (Solid) | 0.0157 |
| 18 | S-2 | 34.8 | J | 100% (Liquid) | 0.0400 |
| 19 | S-2 | 34.8 | J | 100% (Liquid) | 0.0799 |
| 20 | S-2 | 34.8 | J | 100% (Liquid) | 0.1199 |
| 21 | S-2 | 34.8 | K | 100% (Liquid) | 0.0616 |
| 22 | S-2 | 34.8 | K | 100% (Liquid) | 0.1232 |
| 23 | S-2 | 34.8 | K | 100% (Liquid) | 0.1848 |
| 24 | S-2 | 34.8 | N | 100% (Liquid) | 0.0591 |
| 25 | S-2 | 34.8 | N | 100% (Liquid) | 0.1183 |
| 26 | S-2 | 34.8 | N | 100% (Liquid) | 0.1774 |
| 27 | S-2 | 34.8 | P | 100% (Liquid) | 0.0895 |
| 28 | S-2 | 34.8 | P | 100% (Liquid) | 0.1789 |
| 29 | S-2 | 34.8 | P | 100% (Liquid) | 0.2684 |
| 30 | S-2 | 34.8 | Q | 100% (Solid) | 0.0217 |
| CE-5 | S-3 | 400.0 | F | 39.9 wt % (in water) | 0.4459 |
| CE-6 | S-3 | 400.0 | F | 39.9 wt % (in water) | 1.9586 |
| 31 | S-3 | 200.0 | M | 39.9 wt % (in water) | 0.3863 |
| CE-7 | S-4 | 400.0 | F | 39.9 wt % (in water) | 0.4424 |
| CE-8 | S-4 | 400.0 | F | 39.9 wt % (in water) | 1.8391 |
| 32 | S-4 | 200.0 | M | 39.9 wt % (in water) | 0.3833 |
| CE-9 | S-5 | 100.0 | F | 39.9 wt % (in water) | 0.1042 |
| CE-10 | S-5 | 100.0 | F | 39.9 wt % (in water) | 0.2083 |
| 33 | S-5 | 100.0 | H | 100% (Solid) | 0.0096 |
| 34 | S-5 | 100.0 | H | 100% (Solid) | 0.0192 |
| 35 | S-5 | 100.0 | H | 100% (Solid) | 0.0384 |
| 36 | S-5 | 100.0 | G | 100% (Solid) | 0.0298 |

TABLE 11
Examples and comparative examples coated onto polycarbonate
substrates primed with SHP470FT-2050.

| | Silicone | | | | |
|---|---|---|---|---|---|
| | Coating Sol | | Catalyst | | |
| Example | ID | Charge (g) | ID | Type | Charge (g) |
| CE-11 | S-6 | 300 | F | 39.9 wt % (in water) | 0.270 |
| CE-12 | S-6 | 300 | F | 39.9 wt % (in water) | 0.540 |
| 37 | S-6 | 300 | M | 39.9 wt % (in water) | 0.270 |
| 38 | S-6 | 300 | M | 39.9 wt % (in water) | 0.540 |
| CE-13 | S-7 | 300 | F | 39.9 wt % (in water) | 0.270 |
| CE-14 | S-7 | 300 | F | 39.9 wt % (in water) | 0.540 |
| 39 | S-7 | 300 | M | 39.9 wt % (in water) | 0.270 |
| 40 | S-7 | 300 | M | 39.9 wt % (in water) | 0.540 |

TABLE 12
Examples and comparative examples coated
onto unprimed polycarbonate substrates.

| | Silicone | | | | |
|---|---|---|---|---|---|
| | Coating Sol | | Catalyst | | |
| Example | ID | Charge (g) | ID | Type | Charge (g) |
| CE-15 | S-8 | 300 | F | 39.9 wt % (in water) | 0.270 |
| CE-16 | S-8 | 300 | F | 39.9 wt % (in water) | 0.540 |
| 41 | S-8 | 300 | M | 39.9 wt % (in water) | 0.270 |
| 42 | S-8 | 300 | M | 39.9 wt % (in water) | 0.540 |

### Preparation of Polymethylmethacrylate Primer Formulation

Polymethylmethacrylate (PMMA) solutions were prepared by dissolving PMMA resin (Elvacite 2041) in a mixture of 85 wt. % MP and 15 wt % diacetone alcohol (DAA). Solvent dilutions were done with an 85:15 mixture of MP:DAA. Components were combined in an appropriately sized glass or polyethylene bottle then shaken well to mix. The solids content of the solutions was between 2-8 wt % solids so as to give primer coating thicknesses of 0.5 to 3 microns thick when applied to polycarbonate substrates. Primer solutions were allowed to stand for at least 1 hour prior to coating application.

### Preparation of Coated Polycarbonate Panels

The primer formulations were coated on polycarbonate plates according to the following procedure. Polycarbonate (PC) plaques were cleaned with a stream of N₂ gas or deionized air to remove any dust particles adhering to the surface followed by rinsing of the surface with IPA or MP. The plaques were then allowed to dry inside a fume hood for 20 minutes. The primer solutions were then applied to the PC plates by flow coating. The solvent in the primer coating solutions were allowed to flash off in the fume hood for approximately 20 minutes (20-25° C., 35-45% relative humidity) and then placed in a preheated circulated air oven for 125° C. for 20-45 minutes. Panels were cooled to room temperature before hardcoat solutions were applied.

The catalyzed silicone hardcoat examples described in Table 11 were applied to PMMA primed PC panels by flow coating. After drying in a fume hood for approximately 20 minutes (20-22° C., 25-45% RH), the coated plaques were placed in a preheated circulated air oven at 125° C. for 45 minutes to cure the coating. The panels were cooled to room temperature before any further analysis or testing was done.

The catalyzed silicone hardcoat examples described in Table 12 were applied to the SHP470FT-2050 primed PC panels by flow coating. After drying in a fume hood for approximately 20 minutes (20-22° C., 25-45% RH), the coated plaques were placed in a preheated circulated air oven at temperature between 105° C.-125° C. and a time between 15-90 minutes. The panels were cooled to room temperature before any further analysis or testing was done.

The catalyzed silicone hardcoat examples described in Table 13 were applied to the unprimed PC panels by flow coating. After drying in a fume hood for approximately 20 minutes (20-22° C., 25-45% RH), the coated plaques were placed in a preheated circulated air oven at temperature between 105° C.-125° C. and time between 15-90 minutes. The panels were cooled to room temperature before any further analysis or testing was done.

### Analysis of Examples 1-49 and Comparative Examples CE1-CE14

The optical characteristics (transmission and haze) were measured according to ASTM D1003 using a BYK Gardner Haze-Gard™ instrument. Adhesion was measured according to ASTM D3200/D3359 (cross hatch adhesion test). The adhesion is rated on a scale from 5B to 0B, with 5B indicative of the highest level of adhesion. A rating of <4B is considered poor adhesion. Adhesion after water immersion was done by immersing the coated PC plaques in 65° C. hot deionized water for a given period of time followed by cross hatch adhesion testing. Samples with adhesion >4B after 10 days of 65° C. watersoak are considered to have good watersoak adhesion.

The steel wool abrasion resistance test was performed by rubbing grade 0000 steel wool under a weight of 1 Kg on the surface of the coated substrate. The initial haze (Hᵢ) of the coated sample was measured prior to steel wool abrasion then again after rubbing back and forth 5 times (H_{f}). The change in haze (ΔH_{sw}) was calculated as, ΔH_{sw}=H_{f}−Hᵢ.

Taber abrasion testing was done in accordance with ASTM D1003 and D1044, haze measurements were made using a BYK Haze-Gard™ plus hazemeter, ΔHaze values at 500 cycles ΔH₅₀₀) were measured. Three specimens of each example were tested and the average ΔH₅₀₀ value is reported.

Hardness (H) and reduced modulus (Eᵣ) values, were obtained from nanoindentation measurements. The use of H/Eᵣ has been documented in the literature (J. Coat. Technol. Res., 13(4), 677-690. DOI 10.1007/s11998-016-9782-8) as a means to predict wear properties of ceramic and metallic nanocomposite coatings. Testing reported here was performed using a Hysitron® TI 900 TriboIndenter® instrument, equipped with a Berkovich geometry probe. The tests were performed in displacement control mode, and the maximum load for an indent was selected to ensure a consistent contact depth of 5.0±0.1% of topcoat film thickness in the location being tested. The test surfaces of the samples were wiped clean with IPA prior to testing. Each measurement consisted of a three segment load function: a load segment (a five second ramp from zero displacement to the target displacement), a hold segment (a five second hold at the target displacement), and an unload segment (a one second unload back to zero displacement.) A minimum of seven measurements were made on each specimen tested, the average value of these measurements for each example is reported. The average relative standard deviation for the reported values was <2%.

The results of the testing of examples and comparative examples are shown in Tables 13-15.

TABLE 13
Properties of the catalyazed hardcoat formulations
coated on PC primed with polymethylmethacrylate.

| | | Steel Wool | | | | | | | |
|---|---|---|---|---|---|---|---|---|---|
| | | Abrasion | | Taber | | | Adhesion | | |
| | | Resistance | | Abrasion | | | | Water Soak | |
| Example | % T | Hᵢ | ΔH_{SW} | Hᵢ | ΔH₅₀₀ | H/Eᵣ | Initial | @ 10 days | days to <4B |
| 1 | 88.9 | — | — | 0.74 | 15.96 | — | 5B | 5B | >30 |
| 2 | 88.9 | — | — | 0.66 | 8.48 | — | 5B | 5B | >30 |
| 3 | 88.9 | — | — | 0.66 | 16.14 | — | 5B | 5B | >30 |
| 4 | 88.9 | — | — | 0.75 | 4.35 | — | 5B | 5B | >30 |
| 5 | 88.9 | — | — | 0.57 | 18.23 | — | 5B | 5B | >30 |
| 6 | 89 | — | — | 0.7 | 6.3 | — | 5B | 5B | >30 |
| 7 | 88.9 | — | — | 0.85 | 11.65 | — | 5B | 5B | >30 |
| 8 | 89 | — | — | 0.91 | 12.69 | — | 5B | 5B | >30 |
| 9 | 88.9 | — | — | 1.22 | 16.68 | — | 5B | 5B | >30 |
| 10 | 88.6 | — | — | 3.3 | 15.3 | — | 5B | 5B | >30 |
| CE-1 | 88.12 | 0.73 | 7.71 | — | — | — | 5B | 5B | >30 |
| CE-2 | 89.62 | 0.556 | 0.68 | 0.5 | 4.66 | — | 5B | 5B | >30 |
| CE-3 | 89.82 | 0.44 | 0.528 | 1.53 | 8.13 | — | 5B | 5B | >30 |
| CE-4 | 89.9 | 0.408 | 0.578 | 0.53 | 9.38 | — | 5B | 4B | 10 |
| 11 | 88.2 | 0.63 | 3.75 | — | — | — | 5B | 5B | >30 |
| 12 | 88.9 | 0.72 | 0.74 | — | — | — | 5B | 5B | >30 |
| 13 | 89.66 | 0.528 | 0.83 | 0.6 | 7.55 | — | 5B | 5B | >30 |
| 14 | 89.6 | 0.682 | 0.308 | 0.53 | 8.9 | — | 5B | 5B | >30 |
| 15 | 88.62 | 1.274 | 30.786 | — | — | — | 5B | — | — |
| 16 | 88.8 | 0.424 | 2.272 | — | — | — | 5B | 5B | >30 |
| 17 | 89.4 | 0.524 | 0.942 | 0.69 | 4.81 | — | 5B | 5B | >30 |
| 18 | 89.46 | 0.452 | 3.42 | — | — | — | 5B | 5B | >30 |
| 19 | 89.48 | 0.598 | 1.708 | 0.66 | 4.57 | — | 5B | 5B | >30 |
| 20 | 89.6 | 0.626 | 1.066 | — | — | — | 2B | — | — |
| 21 | 89.1 | 0.706 | 0.51 | — | — | — | 5B | 5B | >30 |
| 22 | 89.06 | 0.86 | 0.23 | 0.52 | 8.43 | — | 4B | — | — |
| 23 | 89.04 | 0.64 | 1.66 | — | — | — | 4B | — | — |
| 24 | 88.9 | 0.69 | 0.95 | 0.51 | 5.91 | — | 5B | 5B | >30 |
| 25 | 89.01 | 0.5 | 0.53 | 1.15 | 13.45 | — | 5B | 4B | 6 |
| 26 | 89.14 | 0.64 | 1.9 | — | — | — | 5B | 4B | 6 |
| 27 | 89 | 0.85 | 0.67 | 0.76 | 26.76 | — | 5B | 5B | >30 |
| 28 | 89 | 0.7 | 0.59 | — | — | — | 0B | — | — |
| 29 | 88.7 | 0.75 | 0.98 | — | — | — | 0B | — | — |
| 30 | 88.1 | 0.94 | 5.64 | — | — | — | 5B | 5B | — |
| CE-5 | 88.6 | — | — | 0.3 | 38.7 | 0.03 | 5B | 2B | 6 |
| CE-6 | 89.3 | — | — | 0.3 | 7.7 | 0.08 | 5B | 5B | >32 |
| 31 | 89.5 | — | — | 0.2 | 5.8 | 0.11 | 5B | 5B | >32 |
| CE-7 | 88.9 | — | — | 0.5 | 20.9 | 0.03 | 5B | 4B | 11 |
| CE-8 | 89.0 | — | — | 0.5 | 6.1 | 0.10 | 5B | 5B | >32 |
| 32 | 89.3 | — | — | 0.4 | 5.4 | 0.09 | 5B | 5B | >32 |
| CE-9 | 89.6 | 0.33 | 0.22 | 0.71 | 2.88 | — | 5B | 5B | >30 |
| CE-10 | 89.5 | 0.56 | 0.71 | 0.6 | 5.3 | — | 5B | 5B | >30 |
| 33 | 89.5 | 0.46 | 0.11 | 0.47 | 3.86 | — | 5B | 5B | >30 |
| 34 | 89.7 | 0.32 | 0.3 | — | — | — | 5B | 5B | >30 |
| 35 | 89.7 | 0.33 | 0.14 | 0.29 | 2.91 | — | 5B | 5B | >30 |
| 36 | 89.6 | 0.48 | 0.1 | 0.41 | 3.26 | — | 5B | 5B | >30 |

TABLE 14
Properties of the catalyzed hardcoat formulations coated
onto polycarbonate substrates primed with SHP470FT-2050.

| | | | | Steel Wool | | | Adhesion | | |
|---|---|---|---|---|---|---|---|---|---|
| | Cure Conditions | | | Abrasion | | | | Water Soak | |
| | Temp. | Time | | Resistance | | | | | days to |
| Example | (° C.) | (minutes) | % T | Hᵢ | ΔH_{SW} | H/Eᵣ | Initial | @ 10 days | <4B |
| CE-11 | 125 | 15 | 90.4 | 0.51 | 1.77 | 0.076 | 5B | 5B | >28 |
| | 125 | 30 | 90.6 | 0.52 | 2.31 | 0.087 | 5B | 5B | >28 |
| | 125 | 60 | 90.3 | 0.43 | 1.99 | 0.098 | 5B | 5B | >28 |
| | 125 | 90 | 90.5 | 0.42 | 1.76 | 0.100 | 5B | 5B | >28 |
| | 115 | 15 | 90.5 | 0.53 | 1.77 | 0.066 | 5B | 5B | >28 |
| | 115 | 30 | 90.3 | 0.34 | 2.26 | 0.070 | 5B | 5B | >28 |
| | 115 | 60 | 90.3 | 0.31 | 1.32 | 0.084 | 5B | 5B | >28 |
| | 115 | 90 | 90.4 | 0.52 | 2.59 | 0.075 | 5B | 5B | >28 |
| | 105 | 15 | 90.6 | 0.33 | 3.04 | 0.069 | 5B | 5B | >28 |
| | 105 | 30 | 86.0 | 0.42 | 3.42 | 0.080 | 5B | 5B | >28 |
| | 105 | 60 | 90.6 | 0.31 | 0.82 | 0.086 | 5B | 5B | >28 |
| | 105 | 90 | 88.3 | 0.42 | 2.12 | 0.081 | 5B | 5B | >28 |
| CE-12 | 125 | 15 | 90.2 | 0.62 | 0.00 | 0.081 | 5B | 5B | >28 |
| | 125 | 30 | 90.3 | 0.60 | 0.04 | 0.096 | 5B | 5B | >28 |
| | 125 | 60 | 90.2 | 0.64 | 0.01 | 0.101 | 5B | 5B | >28 |
| | 125 | 90 | 90.2 | 0.45 | 0.00 | 0.097 | 5B | 5B | >28 |
| | 115 | 15 | 90.2 | 0.33 | 0.12 | 0.078 | 5B | 5B | >28 |
| | 115 | 30 | 90.3 | 0.32 | 0.09 | 0.086 | 5B | 5B | >28 |
| | 115 | 60 | 90.3 | 0.17 | 0.15 | 0.085 | 5B | 5B | >28 |
| | 115 | 90 | 90.4 | 0.16 | 0.30 | 0.095 | 5B | 5B | >28 |
| | 105 | 15 | 90.2 | 0.14 | 0.03 | 0.072 | 5B | 5B | >28 |
| | 105 | 30 | 90.3 | 0.16 | 0.00 | 0.085 | 5B | 5B | >28 |
| | 105 | 60 | 90.2 | 0.22 | 0.16 | 0.085 | 5B | 5B | >28 |
| | 105 | 90 | 90.3 | 0.50 | 0.14 | 0.096 | 5B | 5B | >28 |
| 37 | 125 | 15 | 90.6 | 1.15 | 5.01 | 0.077 | 5B | 5B | >28 |
| | 125 | 30 | 87.8 | 0.68 | 2.21 | 0.101 | 5B | 5B | >28 |
| | 125 | 60 | 90.4 | 0.61 | 0.70 | 0.103 | 5B | 5B | >28 |
| | 125 | 90 | 90.6 | 0.85 | 2.06 | 0.107 | 5B | 5B | >28 |
| | 115 | 15 | 90.6 | 0.65 | 1.05 | 0.083 | 5B | 5B | >28 |
| | 115 | 30 | 90.5 | 1.35 | 2.06 | 0.097 | 5B | 5B | >28 |
| | 115 | 60 | 90.6 | 0.98 | 1.13 | 0.099 | 5B | 5B | >28 |
| | 115 | 90 | 90.6 | 0.55 | 1.16 | 0.098 | 5B | 5B | >28 |
| | 105 | 15 | 90.4 | 0.59 | 0.68 | 0.071 | 5B | 5B | >28 |
| | 105 | 30 | 90.6 | 0.64 | 0.38 | 0.088 | 5B | 5B | >28 |
| | 105 | 60 | 90.5 | 0.88 | 0.26 | 0.098 | 5B | 5B | >28 |
| | 105 | 90 | 90.5 | 0.71 | 0.64 | 0.099 | 5B | 5B | >28 |
| 38 | 125 | 15 | 90.3 | 0.55 | 0.07 | 0.096 | 5B | 5B | >28 |
| | 125 | 30 | 90.4 | 0.20 | 0.21 | 0.110 | 5B | 5B | >28 |
| | 125 | 60 | 90.5 | 0.18 | 0.10 | 0.118 | 5B | 5B | >28 |
| | 125 | 90 | 90.3 | 0.51 | — | 0.117 | 5B | 5B | >28 |
| | 115 | 15 | 90.1 | 0.48 | 0.25 | 0.087 | 5B | 5B | >28 |
| | 115 | 30 | 90.2 | 0.15 | 0.45 | 0.093 | 5B | 5B | >28 |
| | 115 | 60 | 90.2 | 0.17 | 0.03 | 0.105 | 5B | 5B | >28 |
| | 115 | 90 | 89.6 | 0.16 | 0.12 | 0.108 | 5B | 5B | >28 |
| | 105 | 15 | 90.0 | 0.15 | 0.18 | 0.086 | 5B | 5B | >28 |
| | 105 | 30 | 89.9 | 0.30 | 0.13 | 0.096 | 5B | 5B | >28 |
| | 105 | 60 | 90.0 | 0.25 | 0.27 | 0.100 | 5B | 5B | >28 |
| | 105 | 90 | 89.9 | 0.16 | 0.27 | 0.107 | 5B | 5B | >28 |
| CE-13 | 125 | 15 | 89.7 | 0.80 | 0.34 | 0.054 | 5B | 5B | >28 |
| | 125 | 30 | 89.0 | 1.16 | 1.05 | 0.054 | 5B | 5B | >28 |
| | 125 | 60 | 89.9 | 0.48 | 0.57 | 0.066 | 5B | 5B | >28 |
| | 125 | 90 | 90.0 | 0.86 | 0.21 | 0.062 | 5B | 5B | >28 |
| | 115 | 15 | 90.0 | 0.72 | 0.72 | 0.050 | 5B | 5B | >28 |
| | 115 | 30 | 89.8 | 1.15 | 0.59 | 0.055 | 5B | 5B | >28 |
| | 115 | 60 | 90.2 | 0.31 | 0.52 | 0.055 | 5B | 5B | >28 |
| | 115 | 90 | 90.1 | 0.27 | 0.14 | 0.050 | 5B | 5B | >28 |
| | 105 | 15 | 89.9 | 0.98 | 0.21 | 0.046 | 5B | 5B | >28 |
| | 105 | 30 | 89.9 | 1.01 | 0.37 | 0.056 | 5B | 5B | >28 |
| | 105 | 60 | 89.9 | 0.61 | 0.02 | 0.054 | 5B | 5B | >28 |
| | 105 | 90 | 90.0 | 0.69 | 0.00 | 0.057 | 5B | 5B | >28 |
| CE-14 | 125 | 15 | 90.0 | 0.36 | 0.69 | 0.065 | 5B | 5B | >28 |
| | 125 | 30 | 89.8 | 0.69 | 0.15 | 0.070 | 5B | 5B | >28 |
| | 125 | 60 | 90.1 | 0.33 | 0.35 | 0.077 | 5B | 5B | >28 |
| | 125 | 90 | 89.9 | 0.67 | 0.00 | 0.080 | 5B | 5B | >28 |
| | 115 | 15 | 89.9 | 0.37 | 0.00 | 0.059 | 5B | 5B | >28 |
| | 115 | 30 | 89.0 | 0.42 | 0.34 | 0.067 | 5B | 5B | >28 |
| | 115 | 60 | 90.0 | 0.22 | 0.25 | 0.070 | 5B | 5B | >28 |
| | 115 | 90 | 89.9 | 0.18 | 0.23 | 0.068 | 5B | 5B | >28 |
| | 105 | 15 | 89.9 | 0.60 | 0.39 | 0.058 | 5B | 5B | >28 |
| | 105 | 30 | 89.9 | 0.28 | 0.57 | 0.064 | 5B | 5B | >28 |
| | 105 | 60 | 90.0 | 0.43 | 0.57 | 0.062 | 5B | 5B | >28 |
| | 105 | 90 | 89.9 | 0.21 | 0.68 | 0.064 | 5B | 5B | >28 |
| 39 | 125 | 15 | 89.9 | 0.36 | 0.11 | 0.066 | 5B | 5B | >28 |
| | 125 | 30 | 90.2 | 0.34 | 0.15 | 0.071 | 5B | 5B | >28 |
| | 125 | 60 | 90.0 | 0.35 | 0.12 | 0.077 | 5B | 5B | >28 |
| | 125 | 90 | 89.7 | 0.72 | 0.29 | 0.082 | 5B | 5B | >28 |
| | 115 | 15 | 89.7 | 0.52 | 0.00 | 0.060 | 5B | 5B | >28 |
| | 115 | 30 | 89.9 | 0.53 | 0.00 | 0.064 | 5B | 5B | >28 |
| | 115 | 60 | 90.0 | 0.37 | 0.11 | 0.068 | 5B | 5B | >28 |
| | 115 | 90 | 90.0 | 0.22 | 0.09 | 0.069 | 5B | 5B | >28 |
| | 105 | 15 | 89.0 | 0.86 | 0.07 | 0.055 | 5B | 5B | >28 |
| | 105 | 30 | 89.9 | 0.97 | 0.20 | 0.058 | 5B | 5B | >28 |
| | 105 | 60 | 90.0 | 0.59 | 0.02 | 0.064 | 5B | 5B | >28 |
| | 105 | 90 | 90.0 | 0.86 | 0.06 | 0.066 | 5B | 5B | >28 |
| 40 | 125 | 15 | 89.9 | 0.34 | 0.53 | — | 5B | 5B | >28 |
| | 125 | 30 | 89.9 | 0.45 | 0.23 | 0.095 | 5B | 5B | >28 |
| | 125 | 60 | 90.1 | 0.4 | 0.18 | 0.097 | 5B | 5B | >28 |
| | 125 | 90 | 90.2 | 0.54 | 0.03 | 0.097 | 5B | 5B | >28 |
| | 115 | 15 | 90.2 | 0.5 | 0.26 | 0.078 | 5B | 5B | >28 |
| | 115 | 30 | 90.0 | 0.36 | 0.09 | 0.081 | 5B | 5B | >28 |
| | 115 | 60 | 90.1 | 0.32 | 0.20 | 0.092 | 5B | 5B | >28 |
| | 115 | 90 | 90.2 | 0.22 | 0.11 | 0.089 | 5B | 5B | >28 |
| | 105 | 15 | 90.0 | 0.57 | 0.66 | 0.068 | 5B | 5B | >28 |
| | 105 | 30 | 90.1 | 0.27 | 0.22 | 0.079 | 5B | 5B | >28 |
| | 105 | 60 | 90.0 | 0.3 | 0.18 | 0.086 | 5B | 5B | >28 |
| | 105 | 90 | 89.7 | 0.49 | 0.35 | — | 5B | 5B | >28 |

TABLE 15
Properties of catalyzed hardcoat formulations
coated onto unprimed polycarbonate substrates.

| | | | | Steel Wool | | | Adhesion | | |
|---|---|---|---|---|---|---|---|---|---|
| | Cure Conditions | | | Abrasion | | | | Water Soak | |
| | Temp. | Time | | Resistance | | | | | days to |
| Example | (° C.) | (minutes) | % T | Hᵢ | ΔH_{SW} | H/Eᵣ | Initial | @ 10 days | <4B |
| CE-15 | 125 | 15 | 89.6 | 0.51 | 0.44 | 0.073 | 0B | — | — |
| | 125 | 30 | 89.8 | 0.52 | 0.36 | 0.079 | 5B | — | 2 |
| | 125 | 60 | 89.9 | 0.43 | 0.84 | 0.084 | 5B | 5B | >28 |
| | 125 | 90 | 89.8 | 0.42 | 0.25 | 0.082 | 5B | — | 2 |
| | 115 | 15 | 89.8 | 0.53 | 0.48 | — | 0B | — | — |
| | 115 | 30 | 89.9 | 0.34 | 1.06 | — | 0B | — | — |
| | 115 | 60 | 90.0 | 0.31 | — | — | 0B | — | — |
| | 115 | 90 | 89.9 | 0.52 | 1.00 | — | 5B | 5B | 12 |
| | 105 | 15 | 89.9 | 0.33 | 0.01 | — | 0B | — | — |
| | 105 | 30 | 89.9 | 0.42 | 1.14 | — | 0B | — | — |
| | 105 | 60 | 89.9 | 0.31 | — | — | 0B | — | — |
| | 105 | 90 | 89.8 | 0.42 | 0.44 | — | 0B | — | — |
| CE-16 | 125 | 15 | 90.0 | 0.27 | 0.59 | — | 0B | — | — |
| | 125 | 30 | 90.0 | 0.19 | 0.09 | — | 5B | — | 5 |
| | 125 | 60 | 90.0 | 0.39 | 0.01 | — | 5B | 5B | >28 |
| | 125 | 90 | 90.0 | 0.31 | 0.07 | — | 5B | 5B | >28 |
| | 115 | 15 | 90.0 | 0.33 | 0.11 | — | 0B | — | — |
| | 115 | 30 | 90.0 | 0.32 | 0.02 | — | 0B | — | — |
| | 115 | 60 | 90.0 | 0.58 | 0.00 | — | 5B | — | 2 |
| | 115 | 90 | 90.0 | 0.35 | 0.02 | — | 5B | — | 2 |
| | 105 | 15 | 90.0 | 0.32 | 0.26 | — | 0B | — | — |
| | 105 | 30 | 90.1 | 0.24 | 0.04 | — | 0B | — | — |
| | 105 | 60 | 89.9 | 0.18 | 0.02 | — | 0B | — | — |
| | 105 | 90 | 90.0 | 0.28 | 0.02 | — | 0B | — | — |
| 41 | 125 | 15 | 89.9 | 0.37 | 0.31 | 0.079 | 5B | — | 2 |
| | 125 | 30 | 90.0 | 0.21 | 0.19 | 0.081 | 5B | 5B | >28 |
| | 125 | 60 | 89.7 | 0.37 | 0.69 | 0.090 | 5B | 5B | >28 |
| | 125 | 90 | 89.9 | 0.39 | 0.06 | 0.083 | 5B | 5B | >28 |
| | 115 | 15 | 89.9 | 0.30 | 0.39 | — | 0B | — | — |
| | 115 | 30 | 89.9 | 0.48 | 0.20 | — | 2B | — | — |
| | 115 | 60 | 89.9 | 0.26 | 0.33 | — | 5B | — | 2 |
| | 115 | 90 | 89.6 | 0.30 | 0.27 | — | 5B | — | 2 |
| | 105 | 15 | 89.8 | 0.28 | 0.83 | — | 0B | — | — |
| | 105 | 30 | 89.8 | 0.36 | 0.64 | — | 0B | — | — |
| | 105 | 60 | 89.8 | 0.28 | 0.40 | — | 2B | — | — |
| | 105 | 90 | 89.7 | 0.50 | — | — | 2B | — | — |
| 42 | 125 | 15 | 89.8 | 0.50 | 0.09 | — | 5B | — | 2 |
| | 125 | 30 | 89.9 | 0.28 | 0.00 | — | 5B | — | 5 |
| | 125 | 60 | 89.8 | 0.26 | 0.02 | — | 5B | 5B | 12 |
| | 125 | 90 | 89.9 | 0.27 | 0.04 | — | 5B | 5B | >28 |
| | 115 | 15 | 89.8 | 0.36 | 0.07 | — | 0B | — | — |
| | 115 | 30 | 90.0 | 0.17 | 0.16 | — | 5B | — | 2 |
| | 115 | 60 | 89.8 | 0.21 | 0.05 | — | 5B | — | 2 |
| | 115 | 90 | 89.8 | 0.24 | 0.07 | — | 5B | — | 2 |
| | 105 | 15 | 90.1 | 0.20 | 0.13 | — | 0B | — | — |
| | 105 | 30 | 89.9 | 0.63 | 0.00 | — | 0B | — | — |
| | 105 | 60 | 90.0 | 0.30 | 0.22 | — | 5B | — | 2 |
| | 105 | 90 | 89.9 | 0.25 | 0.28 | — | 5B | — | 2 |

While the above description contains many specifics, these specifics should not be construed as limitations on the scope of the invention, but merely as exemplifications of preferred embodiments thereof. Those skilled in the art may envision many other possible variations that are within the scope and spirit of the invention as defined by the claims appended hereto.

What is claimed is:

1. A curable silicone hardcoat system comprising (a) a curable silicone-based composition comprising a dispersion of at least one siloxanol resin and at least one colloidal metal oxide, and (b) at least one catalyst, wherein the catalyst is selected from a super base, a salt of a super base, or a combination of two or more thereof.

2. The silicone hardcoat system of claim 1, wherein the super base or salt of a super base has a pKa greater than about 11.

3. The silicone hardcoat system of claim 1, wherein the super base or salt of a super base has a pKa of from about 11 to about 45.

4. The silicone hardcoat system of claim 1, wherein the super base or salt of a super base has a pKa of from about 20 to about 30.

5. The silicone hardcoat system of claim 1, wherein the super base is chosen from an imidazole, an amidine, a guanidine, a multicyclic polyamine, a phosphazene, an azaphosphatraene, or a combination of two or more thereof.

6. The silicone hardcoat system of claim 5, wherein the super base comprises an imidazole compound of the formula: 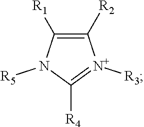 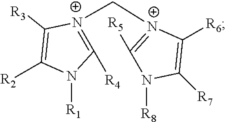
or a combination of two or more thereof, where R₁, R₂, R₃, R₄, R₅, R₆, R₇, and R₈ are independently chosen from hydrogen, an alkyl, a substituted alkyl, an alkenyl, a substituted alkenyl, an alkynyl, a substituted alkynyl, a carbocycle, a heterocycle, an aryl, or a heteroaryl, organosilicone compound having a pendent or grafted cationic group selected from pyridinium, imidazolium, dialkylimidazolium, trialkylimidazolium, dialkylpyrrolidinium, mono or dialkylpyridinium, trialkylsulfonium, oxazolium, thiazolium, oxadiazolium, triazolium, piperidinium, pyrazolium, pyrimidinium, pyrazinium, triazinium, phosphonium, sulfonium, carbazolium, indolium and their derivatives, quaternary amines and quaternary phosphonium, a heterocyclic compound comprising at least one positively charged heteroatom, organosilicon/silane compound comprising one or more positively charged hetero atom or combinations of two or more thereof.

7. The silicone hardcoat system of claim 6, wherein the imidazole compound is a salt comprising a carboxylic acid or halo counterion.

8. The silicone hardcoat system of claim 7, wherein the counterion is chosen from propanoic acid, 2-methyl propanoic acid, butanoic acid, pentanoic acid (valeric acid), hexanoic acid (caproic acid), 2-ethylhexanoic acid, heptanoic acid (enanthic acid), hexanoic acid, octanoic acid (caprylic acid), oleic acid, linoleic acid, linolenic acid, cyclohexanecarboxylic acid, cyclohexylacetic acid, cyclohexenecarboxylic acid, benzoic acid, benzeneacetic acid, propanedioic acid (malonic acid), butanedioic acid (succinic acid), hexanedioic acid (adipic acid), 2-butenedioic acid (maleic acid), lauric acid, stearic acid, myristic acid, palmitic acid, isoanoic acid, Versatic acid, lauric acid, acetic acid, stearic acid, myristic acid, palmitic acid, isoanoic acid, chloride, or iodide.

9. The silicone hardcoat system of claim 5, wherein the catalyst comprises an azaphosphatraene of the formula: 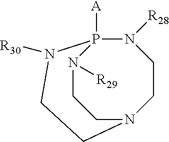
where R₂₈, R₂₉, and R₃₀ are independently chosen from hydrogen, a linear or branched alkyl comprising 1 to 10 carbon atoms, and an aromatic group comprising 6 to 12 carbon atoms, and a substituted phosphorous group with or without nitrogen; A is null or chosen from hydrogen, R₃₁, or (R₃₂R₃₃P—N═)ₜ, where R₃₁, R₃₂, and R₃₃ are independently chosen from hydrogen, a linear or branched alkyl comprising 1 to 10 carbon atoms, and an aromatic group comprising 6 to 12 carbon atoms; and t is 1 to 10.

10. The silicone hardcoat system of claim 1, wherein the catalyst is chosen from imidazole, 2-methylimidazole, 2-ethyl-4-methylimidazole, 2-methyl-4-ethyl imidazole, 2-undecylimidazole, 2-heptadecylimidazole, 2-phenylimidazole, 2-phenyl-4-methylimidazole, 1-benzyl-2-methylimidazole, 2-ethylimidazole, 2-isopropylimidazole, 2-phenyl-4-benzylimidazole, 1-cyanoethyl-2-methylimidazole, 1-cyanoethyl-2-ethyl-4-methylimidazole, 1-cyanoethyl-2-undecylimidazole, 1-cyanoethyl-2-isopropylimidazole, 1-cyanoethyl-2-phenylimidazole, 2,4-diamino-6-[2′-methylimidazolyl-(1)]′-ethyl-s-triazine, 2,4-diamino-6-[2′-ethyl-4-methylimidazolyl-(1)]′-ethyl-s-triazine, 2,4-diamino-6-[2′-undecylimidazolyl-(1)]′-ethyl-s-triazine, 2-methyl-imidazo-lium-isocyanuric acid adduct, 2-phenylimidazolium-isocyanuric acid adduct, 1-aminoethyl-2-methylimidazole, 2-phenyl-4,5-dihydroxymethylimidazole, 2-phenyl-4-methyl-5-hydroxymethylimidazole, 2-phenyl-4-benzyl-5-hydroxymethylimidazole, or a combination of two or more thereof.

11. The silicone hardcoat system of claim 1, wherein the catalyst is chosen from compounds comprising 2 or more imidazole rings per molecule and condensed with formaldehyde.

12. The silicone hardcoat system of claim 1, wherein the catalyst is provided in an amount ranging from about 1 ppm to about 75 ppm.

13. The silicone hardcoat system of claim 1, wherein the catalyst is provided in an amount ranging from about 10 ppm to about 70 ppm.

14. The silicone hardcoat system of claim 1, wherein the catalyst is provided in an amount ranging from about 15 ppm to about 60 ppm.

15. The silicone hardcoat system of claim 1 further comprising an organic UV-absorbing material, an inorganic UV-absorbing material or a combination thereof.

16. The silicone hardcoat system of claim 15, wherein the silicone hardcoat system comprises from about 10% to about 50% by weight of solids.

17. The silicone hardcoat system of claim 1, wherein the UV-absorbing material is chosen from cerium oxide, titanium oxide, zinc oxide, or a combination of two or more thereof.

18. The silicone hardcoat system of claim 1, wherein the siloxanol resin is derived from a partial condensate of a silanol of the formula RSi(OH)₃ where R is an alkyl group comprising 1 to 3 carbonatoms.

19. The silicone hardcoat system of claim 1, wherein the colloidal metal oxide is chosen from colloidal silica, colloidal CeO₂, or a combination of two or more thereof.

20. A coated article comprising:
a polymeric substrate; and
a silicone hardcoat layer disposed on at least a portion of a surface of the substrate, the silicone hardcoat layer comprising the curable silicone hardcoat system of claim 1.

21. The article of claim 20, wherein the substrate comprises a poly(methylmethacrylate), a polyamide, a polyimide, an acrylonitrile-styrene copolymer, a styrene-acrylonitrile-butadiene terpolymer, a polyvinyl chloride, a polyethylene, a polycarbonate, a copolycarbonate, or a combination of two or more thereof.

22. The article of claim 20, further comprising a primer layer disposed between the silicone hardcoat layer and the polymeric substrate.

23. The article of claim 20, wherein the primer is chosen from a homopolymer of an alkyl acrylate, a copolymer of an alkyl acrylate, a polyurethane, a polycarbonate, a urethane hexaacrylate, a pentaerythritol triacrylate, a polyvinylpyrrolidone, a polyvinylbutyral, a poly(ethylene terephthalate), poly(butylene terephthalate), or a combination of two or more thereof.

24. The article of claim 20, wherein the inorganic UV-absorbing material is present in an amount ranging from about 1 wt. % to about 50 wt. % of dry weight of the silicone hardcoat system.

25. A method of forming a curable silicone hardcoat composition comprising adding a catalyst chosen from catalyst a super base, a salt of a super base, or a combination of two or more thereof to a silicone hardcoat composition comprising a curable silicone material.

26. A method of preparing a coated article comprising:
applying a silicone hardcoat composition to at least a portion of a surface of an article, the silicone hardcoat composition comprising (a) a curable silicone composition comprising at least one siloxanol resin and at least one colloidal metal oxide, and (b) at least one catalyst chosen from catalyst a super base, a salt of a super base, or a combination of two or more thereof; and
curing the silicone hardcoat composition to form a cured coating layer.

27. The method of claim 26, wherein the cured coating layer is further treated by a vacuum deposition processes.
